(19) United States
(12) Patent Application Publication
(10) Pub. No.: US 2025/0358336 A1
(43) Pub. Date: Nov. 20, 2025

(54) ELECTRONIC DEVICE, MOBILE TERMINAL, AND METHOD FOR MOBILE TERMINAL TO CONTROL ELECTRONIC DEVICE

(71) Applicant: HISENSE VISUAL TECHNOLOGY CO., LTD., Shandong (CN)

(72) Inventors: Jingxian WANG, Shandong (CN); Hu SONG, Shandong (CN); Chengchuang XIAO, Shandong (CN); Xiujuan PANG, Shandong (CN)

(21) Appl. No.: 19/286,668

(22) Filed: Jul. 31, 2025

Related U.S. Application Data
(63) Continuation of application No. PCT/CN2023/135222, filed on Nov. 29, 2023.

(30) Foreign Application Priority Data
Feb. 10, 2023 (CN) 202310109829.4
Jun. 27, 2023 (CN) 202310772834.3
Jul. 27, 2023 (CN) 202310936037.4
Jul. 27, 2023 (CN) 202310938000.5
Aug. 14, 2023 (CN) 202311016639.4

(51) Int. Cl. H04L 67/125; H04W 12/069

(52) U.S. Cl. CPC H04L 67/125; H04W 12/069

(57) ABSTRACT

The present application relates to an electronic device, a mobile terminal, and a method for a mobile terminal to control an electronic device. The electronic device includes a processor, which is configured to: in response to a received device attestation certificate request sent by a mobile terminal, send a device attestation certificate to the mobile terminal, such that the mobile terminal performs security attestation according to the device attestation certificate; after a node operation certificate sent by the mobile terminal is received, install the node operation certificate and perform network configuration, such that the electronic device and the mobile terminal are in the same ecological system; and receive operation information sent by the mobile terminal, and determine a corresponding control command according to the operation information, so as to execute a corresponding operation according to the control command.

### CROSS-REFERENCES TO RELATED APPLICATIONS

The application is a continuation of International Application No. PCT/CN2023/135222, filed on Nov. 29, 2023, which claims the priority to Chinese patent application No. 202310109829.4, filed with the China National Intellectual Property Administration on Feb. 10, 2023, the priority to Chinese patent application No. 202310772834.3, filed with the China National Intellectual Property Administration on Jun. 27, 2023, the priority to Chinese patent application No. 202310936037.4, filed with the China National Intellectual Property Administration on Jul. 27, 2023, the priority to Chinese patent application No. 202310938000.5, filed with the China National Intellectual Property Administration on Jul. 27, 2023, and the priority to Chinese patent application No. 202311016639.4, filed with the China National Intellectual Property Administration on Aug. 14, 2023, all of which are hereby incorporated by reference in their entireties.

### TECHNICAL FIELD

The present application relates to the technical field of electronic devices, and in particular, to an electronic device, a mobile terminal, and a method for a mobile terminal to control an electronic device.

### BACKGROUND

With the increasing number of smart home terminals, the interconnection and intercommunication among different smart terminals have brought convenience to users. Due to the development of multi-screen interaction technology, users can control functions such as turning on/off and volume adjustment of a television by operating the multi-screen interaction application on the mobile terminal. Currently, different brand manufacturers have developed different multi-screen interaction applications that can be installed on mobile terminals such as mobile phones. For a television to be controlled by a mobile phone, it is necessary to integrate services provided by different brand manufacturers and carry out corresponding adaptation and development. However, in practical applications, the television usually integrates services corresponding to only one or two multi-screen interaction applications, making it difficult to adapt to the diverse multi-screen interaction applications on mobile phones. As a result, the adaptability of the electronic device in controlled scenarios is relatively low.

### SUMMARY

Embodiments of the present disclosure provide an electronic device, including: at least one processor configured to execute instructions to cause the electronic device to: in response to receiving a device attestation certificate request from any one of mobile terminals of different brand manufacturers, send a device attestation certificate to the mobile terminal for the mobile terminal to perform security attestation based on the device attestation certificate; in response to receiving a node operational certificate from the mobile terminal, install the node operational certificate and perform network configuration so that the electronic device and the mobile terminal both belong to one ecosystem; wherein, the electronic device is in different ecosystems to which the mobile terminals of different brand manufacturers belong, to be controlled by the mobile terminals in the different ecosystems; receive operation information from the mobile terminal, determine a control command corresponding to the operation information based on the operation information and execute a corresponding operation according to the control command.

Embodiments of the present disclosure provide a mobile terminal, including: at least one processor configured to execute instructions to cause the mobile terminal to: send a device attestation certificate request to an electronic device; in response to receiving a device attestation certificate returned by the electronic device, send the device attestation certificate to a server for the server to perform security attestation; in response to receiving an attestation success message returned by the server, send a node operational certificate to the electronic device so that the electronic device and the mobile terminal both belong to one ecosystem, wherein the attestation success message indicates that the electronic device passes the security attestation; receive operation information from a user and send the operation information to the electronic device to control the electronic device based on the operation information.

Embodiments of the present disclosure provide a method for a mobile terminal to control an electronic device, including: in response to receiving a device attestation certificate request from the mobile terminal, sending a device attestation certificate to the mobile terminal for the mobile terminal to perform security attestation based on the device attestation certificate; wherein the mobile terminal is any one of mobile terminals of different brand manufacturers; in response to receiving a node operational certificate from the mobile terminal, installing the node operational certificate and performing network configuration so that the electronic device and the mobile terminal both belong to one ecosystem; where, the electronic device is in different ecosystems to which the mobile terminals of different brand manufacturers belong, to be controlled by the mobile terminals in the different ecosystems; receiving operation information from the mobile terminal, determining a control command corresponding to the operation information based on the operation information and executing a corresponding operation according to the control command.

### BRIEF DESCRIPTION OF FIGURES

FIG. 1 is a schematic diagram of a scenario in some embodiments according to the embodiments of the present application.

FIG. 2 is a configuration block diagram of a control device 100 according to the embodiments of the present application.

FIG. 3 is a hardware configuration block diagram of an electronic device 200 according to the embodiments of the present application.

FIG. 4 is a schematic diagram of software configuration in an electronic device 200 according to the embodiments of the present application.

FIG. 5 is a first structural schematic diagram of a mobile terminal according to the embodiments of the present application.

FIG. 6 is a second structural schematic diagram of a mobile terminal according to the embodiments of the present application.

FIG. 7 is a first flowchart of a method for a mobile terminal to control an electronic device according to the embodiments of the present application.

FIG. 8 is a schematic diagram of a relationship between endpoints and clusters according to the embodiments of the present application.

FIG. 9 is a second flowchart of a method for a mobile terminal to control an electronic device according to the embodiments of the present application.

FIG. 10 is a third flowchart of a method for a mobile terminal to control an electronic device according to the embodiments of the present application.

FIG. 11 is a first flowchart of a service control method according to the embodiments of the present application.

FIG. 12 is a second flowchart of a service control method according to the embodiments of the present application.

FIG. 13 is a third flowchart of a service control method according to the embodiments of the present application.

FIG. 14 is a fourth flowchart of a service control method according to the embodiments of the present application.

FIG. 15 is a fifth flowchart of a service control method according to the embodiments of the present application.

FIG. 16 is a sixth flowchart of a service control method according to the embodiments of the present application.

FIG. 17 is a seventh flowchart of a service control method according to the embodiments of the present application.

FIG. 18 is an eighth flowchart of a service control method according to the embodiments of the present application.

FIG. 19 is a schematic diagram of a scenario where a master device configures a network for a controlled device according to the embodiments of the present application.

FIG. 20 is a flowchart of a master device 1 configuring a network for a controlled device 2 according to the embodiments of the present application.

FIG. 21 is a schematic diagram of a system architecture for a controlled device 2 to implement a Matter service according to the embodiments of the present application.

FIG. 22 is a schematic diagram of a system architecture for a controlled device to implement a Matter service according to the embodiments of the present application.

FIG. 23 is a flowchart of device attestation between a controlled device and a master device according to the embodiments of the present application.

FIG. 24 is a flowchart of certificate chain exchange between a controlled device and a master device according to the embodiments of the present application.

FIG. 25 is a flowchart of a controlled device switching from REE to TEE according to the embodiments of the present application.

FIG. 26 is a mode diagram of a controlled device according to the embodiments of the present application.

FIG. 27 is a flowchart of a controlled device signing attestation data through a first application and a second application according to the embodiments of the present application.

FIG. 28 is a flowchart of a controlled device calling a first application according to the embodiments of the present application.

FIG. 29 is a schematic diagram of a CA and a TA of a controlled device according to the embodiments of the present application.

FIG. 30 is a flowchart of a controlled device using a private key to sign attestation data by a second application according to the embodiments of the present application.

FIG. 31 is a schematic diagram of service modules in a TEE according to the embodiments of the present application.

FIG. 32 is a flowchart of a controlled device sending signed data to a master device according to the embodiments of the present application.

FIG. 33 is a flowchart of a device attestation process between a master device and a controlled device according to the embodiments of the present application.

FIG. 34 is a flowchart of a controlled device displaying a list of master devices according to the embodiments of the present application.

FIG. 35 is a schematic diagram of a list of master devices according to the embodiments of the present application.

FIG. 36 is a schematic diagram of a list of master devices according to the embodiments of the present application.

FIG. 37 is a schematic diagram of a list of master devices according to the embodiments of the present application.

FIG. 38 is a flowchart of a controlled device updating a list of master devices according to the embodiments of the present application.

FIG. 39 is an interaction schematic diagram of a controlled device updating a list of master devices according to the embodiments of the present application.

FIG. 40 is an interaction schematic diagram of a controlled device updating a list of master devices according to the embodiments of the present application.

FIG. 41 is a flowchart of a controlled device displaying complete device information according to the embodiments of the present application.

FIG. 42 is an interaction schematic diagram of a controlled device displaying complete device information according to the embodiments of the present application.

FIG. 43 is a flowchart of a controlled device removing a master device according to the embodiments of the present application.

FIG. 44 is an interaction schematic diagram of a controlled device removing a master device according to the embodiments of the present application.

FIG. 45 is a flowchart of a controlled device modifying control permissions of a master device according to the embodiments of the present application.

FIG. 46 is an interaction schematic diagram of a controlled device modifying control permissions of a master device according to the embodiments of the present application.

FIG. 47 is a flowchart of a controlled device renaming a master device according to the embodiments of the present application.

FIG. 48 is an interaction schematic diagram of a controlled device renaming a master device according to the embodiments of the present application.

FIG. 49 is a flowchart of a device network configuration method according to the embodiments of the present application.

FIG. 50 is a flowchart of generating network-configurable device information through speech recognition according to the embodiments of the present application.

FIG. 51 is a schematic diagram of a process in which a terminal device scans a pairing code according to the embodiments of the present application.

FIG. 52 is a flowchart of pairing according to network-configurable device information within a first preset range according to the embodiments of the present application.

FIG. 53 is a flowchart of determining pairing failure according to a first pairing duration according to the embodiments of the present application.

FIG. 54 is a flowchart of refreshing a first pairing duration according to added network-configurable device information according to the embodiments of the present application.

FIG. 55 is a flowchart of pairing according to network-configurable device information within a second preset range according to the embodiments of the present application.

FIG. 56 is a flowchart of performing pairing according to network configuration feedback information according to the embodiments of the present application.

### DETAILED DESCRIPTION

To enable a clearer understanding of the above objectives, features, and advantages of the present application, solutions of the present application will be further described below. It should be noted that the embodiments of the present application and the features in the embodiments can be combined with each other without conflict.

Numerous specific details are set forth in the following description to facilitate a thorough understanding of the present application. However, the present application can also be implemented in a way other than those described herein. Obviously, the embodiments in the description are only some rather than all of the embodiments of the present application.

With the intelligent development of home devices, more and more internet of things (IoT) manufacturers have developed their own unique ecosystems. Smart home devices produced by each brand manufacturer can only be controlled through their own multi-screen interaction applications and cannot interconnect with other devices. Smart home devices under different ecosystems are difficult to work together, which affects the user experience. Currently, if an electronic device wants to be controlled by multi-screen interaction applications developed by different brand manufacturers, it needs to integrate services provided by these brand manufacturers and carry out corresponding adaptation and development. However, in practical applications, due to limitations such as cost and computing power, the electronic device cannot integrate all services, making it difficult for the electronic device to adapt to various multi-screen interaction applications on mobile phones, and also difficult for the electronic device to adapt to diversified controlled scenarios.

To solve the above technical problems, the embodiments of the present application provide an electronic device, a mobile terminal, and a method for the mobile terminal to control the electronic device. The electronic device includes at least one processor. The at least one processor is configured to: first, in response to receiving a device attestation certificate request sent by the mobile terminal, send the requested device attestation certificate to the mobile terminal, so that the mobile terminal performs security attestation based on the device attestation certificate; then, in response to receiving a node operational certificate sent by the mobile terminal, install the node operational certificate and configure the network, so that the electronic device and the mobile terminal are in the same ecosystem; and further, receive operation information sent by the mobile terminal, determine a corresponding control command according to the operation information and execute a corresponding operation based on the control command. The electronic device is not limited to being controlled by mobile terminals developed by individual or specific brand manufacturers, and can join ecosystems of different brand manufacturers, breaking through the technical barrier between different brand manufacturers. This allows various mobile terminals to control the electronic device according to unified standards, improving the adaptability of the electronic device in controlled scenarios.

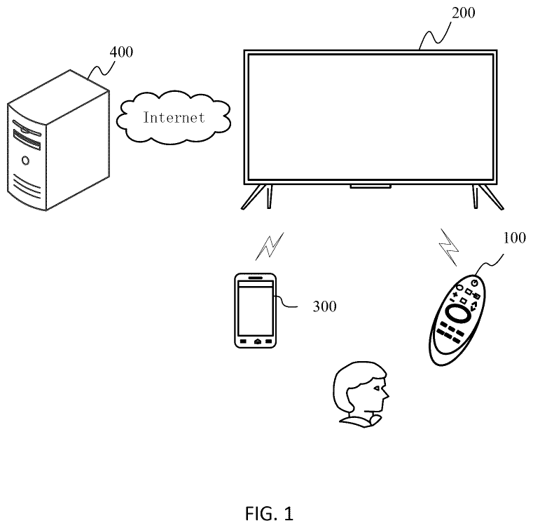

FIG. 1 is a schematic diagram of a scenario in some embodiments according to the embodiments of the present application. As shown in FIG. 1, a control device 100, an electronic device 200, a mobile terminal 300, and a server 400 are shown. A user can operate the electronic device 200 through the mobile terminal 300 or the control device 100 to play audio and video resources on the electronic device 200.

In the scenario shown in FIG. 1, the user operates the electronic device 200 through the mobile terminal 300. First, the mobile terminal 300 sends a device attestation certificate request to the electronic device 200. The electronic device 200, in response to receiving the device attestation certificate request, sends a device attestation certificate to the mobile terminal 300, so that the mobile terminal 300 performs security attestation based on the device attestation certificate. After the security attestation is passed, the mobile terminal 300 sends a node operational certificate to the electronic device 200. In response to receiving the node operational certificate, the electronic device 200 installs the node operational certificate and configures the network, so that the electronic device 200 and the mobile terminal 300 are in the same network, enabling the electronic device 200 to join the ecosystem to which the mobile terminal belongs. Based on that the electronic device 200 and the mobile terminal 300 are in the same ecosystem, the electronic device 200 receives operation information sent by the mobile terminal 300, determines a corresponding control command according to the operation information and executes a corresponding operation based on the control command, realizing the control of the electronic device 200 through the mobile terminal 300. Through the above process, the electronic device 200 can join ecosystems to which different mobile terminals belong, and thus can be controlled by mobile terminals of different brand manufacturers, effectively improving the adaptability of the electronic device in controlled scenarios.

In some embodiments, the control device 100 can be a remote control. The communication between the remote control and the electronic device includes infrared protocol communication, Bluetooth protocol communication, wireless or other wired ways to control the electronic device 200. The user can input a user command through keys on the remote control, voice input, control panel input, etc., to control the electronic device 200. In some embodiments, a mobile terminal, a tablet computer, a computer, a laptop computer, and other mobile terminals can also be used to control the electronic device 200.

In some embodiments, the mobile terminal 300 and the electronic device 200 can have software applications installed, and realize connection and communication through network communication protocols to achieve one-to-one control operations and data communication. The audio and video content displayed on the mobile terminal 300 can also be transmitted to the electronic device 200 to realize a synchronous display function. The electronic device 200 also performs data communication with the server 400 through various communication methods. The electronic device 200 may be allowed to perform communication connection through a local area network (LAN), a wireless local area network (WLAN), and other networks. The server 400 can provide various contents and interactions to the electronic device 200. The electronic device 200 can be a liquid crystal display, an organic light-emitting diode (OLED) display, or a projection electronic device. In addition to providing the broadcast television reception function, the electronic device 200 can also additionally provide an intelligent network television function with computer support functions.

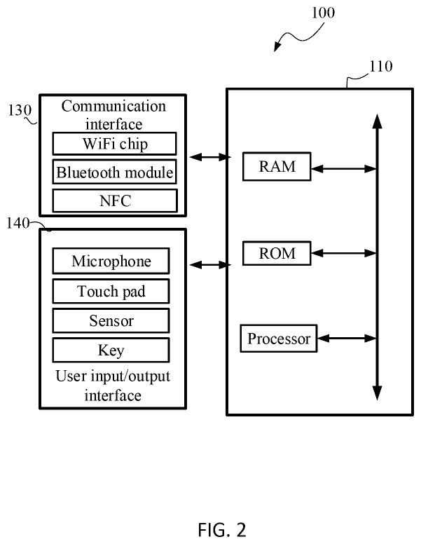

FIG. 2 is a configuration block diagram of a control device 100 according to the embodiments of the present application. As shown in FIG. 2, the control device 100 includes at least one processor 110, a communication interface 130, a user input/output interface 140, a memory, and a power supply. The control device 100 can receive input operation commands from the user and convert the operation commands into instructions that the electronic device 200 can recognize and respond to, acting as an intermediary for interaction between the user and the electronic device 200. The communication interface 130 is configured to communicate with the outside, including at least one of a WIFI chip, a Bluetooth module, near field communication (NFC), or an alternative module. The user input/output interface 140 includes at least one of a microphone, a touch panel, a sensor, a key, or an alternative module.

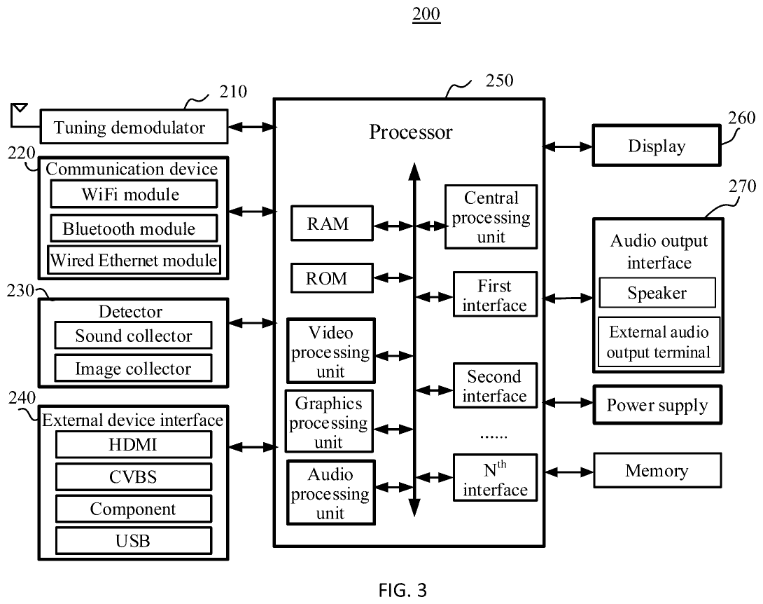

FIG. 3 is a hardware configuration block diagram of an electronic device 200 according to the embodiments of the present application. As shown in FIG. 3, the electronic device 200 includes: a tuning demodulator 210, a communication device 220, a detector 230, an external device interface 240, at least one processor 250, a display 260, an audio output interface 270, a memory, a power supply, etc. The at least one processor 250 includes a central processing unit, a video processing unit, an audio processing unit, a graphics processing unit, a random access memory (RAM), a read-only memory (ROM), and a first to N^{th} interfaces for input/output. The display 260 can be at least one of a liquid crystal display, an OLED display, a touch display or a projection display, and can also be a projection device and a projection screen. The tuning demodulator 210 receives broadcast television signals through wired or wireless reception methods and demodulates audio and video signals, such as electronic program guide (EPG) data signals, from multiple wireless or wired broadcast television signals. The detector 230 is configured to collect signals from the external environment or signals interacting with the outside. The at least one processor 250 and the tuning demodulator 210 can be located in different separate devices, that is, the tuning demodulator 210 can also be in an external device of the main device where the at least one processor 250 is located, such as an external set-top box.

In some embodiments, the above electronic device is a terminal device with a display function, such as a television, a mobile phone, a computer, a learning machine, etc.

In some embodiments, the at least one processor 250 controls the operation of the electronic device and responds to user operations through various software control programs stored in the memory. The at least one processor 250 controls the overall operation of the electronic device 200. The user can input user commands on a graphical user interface (GUI) displayed on the display 260, and the user input interface receives the user input commands through the GUI. Alternatively, the user can input user commands through specific sounds or gestures, and the user input interface recognizes the sounds or gestures through sensors to receive the user input commands.

The output interface (a display 260 and/or an audio output interface 270) is configured to output user interaction information. The communication device 220 is configured to communicate with a server 400 or other devices.

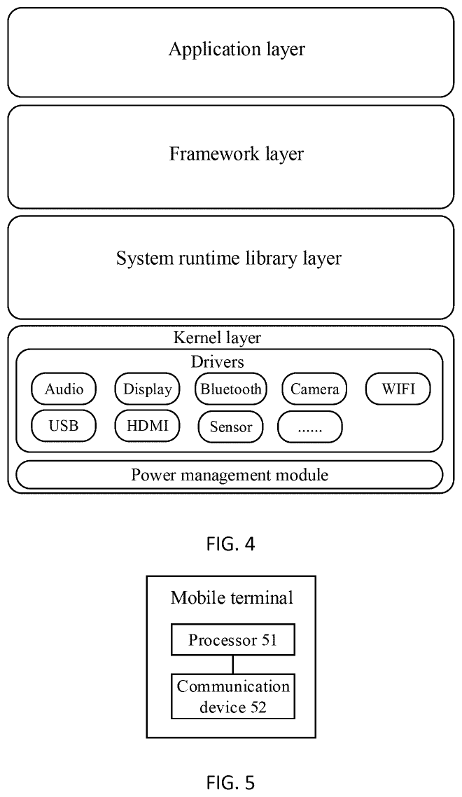

As shown in FIG. 4, which is a schematic diagram of software configuration in an electronic device 200 according to the embodiments of the present application, the system is divided into four layers from top to bottom: an application (Applications) layer, an application framework layer (referred to as the “framework layer”), an Android runtime and system library layer (referred to as the “system runtime library layer”), and a kernel layer. The kernel layer includes at least one of the following drivers: an audio driver, a display driver, a Bluetooth driver, a camera driver, a WIFI driver, a universal serial bus (USB) driver, an high-definition multimedia interface (HDMI) driver, a sensor driver (such as a fingerprint sensor, a temperature sensor, a pressure sensor, etc.), and a power driver. The method for a mobile terminal to control an electronic device provided by the embodiments of the present application can be implemented based on the above electronic device.

The embodiments of the present application provide an electronic device 200, which includes: at least one processor 250 configured to: in response to receiving a device attestation certificate request from a mobile terminal 300, send a device attestation certificate to the mobile terminal 300, so that the mobile terminal 300 performs security attestation based on the device attestation certificate; in response to receiving a node operational certificate from the mobile terminal 300, install the node operational certificate and perform network configuration, so that the electronic device 200 and the mobile terminal 300 are in the same ecosystem; and receive operation information from the mobile terminal 300, determine a corresponding control command according to the operation information and execute a corresponding operation according to the control command.

In some embodiments, the at least one processor 250, configured to install the node operational certificate and perform network configuration in response to receiving the node operational certificate from the mobile terminal 300, is configured to: in response to receiving the node operational certificate from the mobile terminal 300, verify whether the node operational certificate is valid according to a root certificate, where the root certificate corresponds to the ecosystem to which the mobile terminal 300 belongs; and based on that the node operational certificate is valid, install the node operational certificate and perform network configuration.

In some embodiments, the at least one processor 250, configured to receive operation information from the mobile terminal 300, determine the corresponding control command according to the operation information and execute the corresponding operation according to the control command, is configured to: based on that the electronic device 200 and the mobile terminal 300 are in the same ecosystem, in response to the received operation information from the mobile terminal 300, determine whether the operation information is from the mobile terminal 300 according to a root certificate, wherein the root certificate corresponds to the ecosystem; and based on determining that the operation information is from the mobile terminal 300, determine the corresponding control command according to the operation information, and execute the corresponding operation according to the control command.

In some embodiments, after installing the node operational certificate and performing network configuration in response to receiving the node operational certificate from the mobile terminal 300, and before receiving the operation information from the mobile terminal 300, determining the corresponding control command according to the operation information and executing the corresponding operation according to the control command, the at least one processor 250 is further configured to: obtain an access control list, where the access control list includes information of an authorized terminal and authorized operation information corresponding to the authorized terminal.

Correspondingly, the at least one processor 250, configured to receive the operation information from the mobile terminal 300, determine the corresponding control command according to the operation information and execute the corresponding operation according to the control command, is configured to: receive the operation information from the mobile terminal 300, where the operation information includes information of the mobile terminal 300; determine whether the mobile terminal 300 is the authorized terminal according to the information of the mobile terminal 300 and the information of the authorized terminal, and determine whether the operation information is the authorized operation information according to the operation information and the authorized operation information; and based on that the mobile terminal 300 is the authorized terminal and the operation information is the authorized operation information, determine the corresponding control command according to the operation information, and execute the corresponding operation according to the control command.

In some embodiments, before sending the device attestation certificate to the mobile terminal 300 in response to receiving the device attestation certificate request from the mobile terminal 300, the at least one processor 250 is further configured to: control a communication device 220 to broadcast, so that the mobile terminal 300 detects the electronic device 200; in response to a feedback message from the mobile terminal 300, establish a wireless connection with the mobile terminal 300; and send a device parameter to the mobile terminal 300 via the wireless connection, so that the mobile terminal 300 sends the device attestation certificate request to the electronic device 200 according to the device parameter.

In some embodiments, after sending the device attestation certificate to the mobile terminal 300 in response to receiving the device attestation certificate request from the mobile terminal 300, the at least one processor 250 is further configured to: in response to receiving an attestation failure message from the mobile terminal 300, control a display 260 to display prompt information, based on that the attestation failure message indicates that the electronic device 200 has not passed security attestation.

As shown in FIG. 5, FIG. 5 is a first structural schematic diagram of a mobile terminal according to the embodiments of the present application. The mobile terminal includes: at least one processor 51 configured to: send a device attestation certificate request to the electronic device 200; in response to receiving a device attestation certificate returned by the electronic device 200, send the device attestation certificate to a server 400, so that the server 400 performs security attestation; in response to receiving an attestation success message returned by the server 400, send a node operational certificate to the electronic device 200, so that the electronic device 200 and the mobile terminal 300 are in the same ecosystem; where the attestation success message indicates that the electronic device passes security attestation; and receive operation information from a user and send the operation information to the electronic device 200 to control the electronic device 200 according to the operation information.

It should be noted that the mobile terminal 300 also includes a communication device 52, a display and other modules. The present application is not limited thereto.

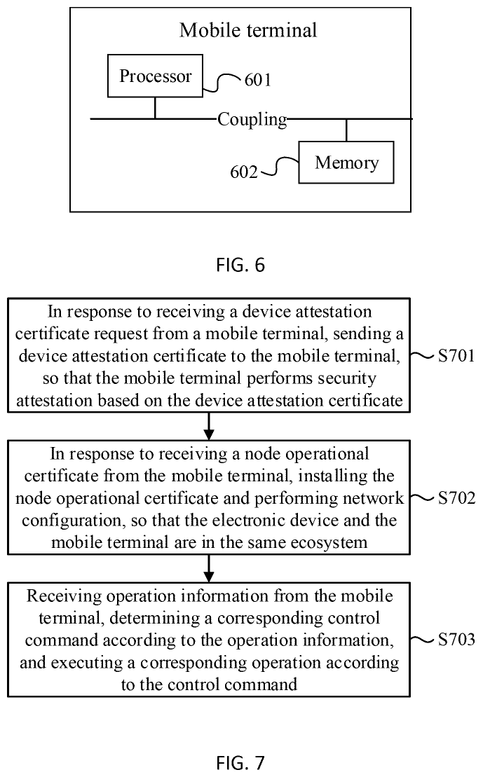

As shown in FIG. 6, FIG. 6 is a second structural schematic diagram of a mobile terminal according to the embodiments of the present application. The mobile terminal includes: at least one processor 601, a memory 602, and computer programs stored on the memory 602 and executable by the at least one processor 601. The computer programs, when executed by the at least one processor 601, can implement each process of the method for a mobile terminal to control an electronic device, and can achieve the same technical effect. To avoid repetition, details are not repeated here.

To explain the solution in more detail, the following description will be given by way of example in conjunction with FIG. 7. It should be understood that the steps involved in FIG. 7 may include more or fewer steps in actual implementation, and the order of these steps may also vary, whichever is capable of realizing the method for a mobile terminal to control an electronic device according to the embodiments of the present application.

As shown in FIG. 7, which is a first flowchart of a method for a mobile terminal to control an electronic device according to the embodiments of the present application, the method includes the following steps S701 to S703.

S701: In response to receiving a device attestation certificate request from a mobile terminal, sending a device attestation certificate to the mobile terminal, so that the mobile terminal performs security attestation based on the device attestation certificate.

Herein, the device attestation certificate request is used to request the device attestation certificate of the electronic device. The device attestation certificate (DAC) is signed by a certificate authority (CA), written into the electronic device during the manufacturing process of the electronic device, and used to prove the identity of the electronic device, to ensure that the electronic device can be added to other ecosystems, thereby allowing interactive operations with other devices in the ecosystem.

In some embodiments, on the mobile terminal side, a device attestation certificate request is sent to the electronic device; and in response to receiving the device attestation certificate returned by the electronic device in response to the device attestation certificate request, the device attestation certificate is used for security attestation. Optionally, the mobile terminal uploads the device attestation certificate to a server, and the server verifies the validity of the device attestation certificate to determine whether the security attestation is passed. Herein, the server is a distributed compliance ledger (DCL) server. The DCL is a cryptographically encrypted, secure and distributed network, where public information of specific devices is published by internet of things (IoT) device manufacturers, authorized testing organizations, and certification teams of alliances. When it is determined that the security attestation is passed, the DCL server sends an attestation success message to the mobile terminal to notify the mobile terminal that the device attestation certificate sent by the electronic device is legitimate and has passed the security attestation. This ensures the security of the mobile terminal controlling the electronic device.

In some embodiments, before step S701 is executed, an implementation manner provided by the embodiments of the present application is as follows: the electronic device controls a communication device configured therein to broadcast, so that the mobile terminal detects the electronic device. The communication device includes but is not limited to: a local area network device discovery protocol (multicast Domain Name System, mDNS), a Bluetooth module (Bluetooth Low Energy, BLE), and near field communication (NFC). For example, the electronic device controls to turn on the Bluetooth module for broadcasting, so that the mobile terminal detects the electronic device by listening to the Bluetooth broadcast. After the mobile terminal discovers the electronic device, the mobile terminal sends a feedback message to the electronic device, thereby establishing the wireless connection between the electronic device and the mobile terminal. Further, the electronic device sends the device parameters of the electronic device to the mobile terminal through the wireless connection, so that the mobile terminal determines the identity of the electronic device according to these device parameters, and then sends a device attestation certificate request to the electronic device.

In some embodiments, after the wireless connection is established between the electronic device and the mobile terminal, the password authenticated session establishment (PASE) is established, so that the device attestation certificate is sent to the mobile terminal based on the encryption mechanism of the PASE. It should be noted that this PASE is closed after step S702 is executed.

For example, a quick response (QR) code is displayed on the electronic device. After the user operates the mobile terminal to scan the QR code, a PASE is established between the electronic device and the mobile terminal to ensure the security of the subsequent communication interaction.

S702: In response to receiving a node operational certificate from the mobile terminal, installing the node operational certificate and performing network configuration, so that the electronic device and the mobile terminal are in the same ecosystem.

The node operational certificate (NOC) adheres the X.509 format standard and contains a unique identifier that can be used to identify a node, i.e., a node operational identifier (node ID). The mobile terminal is configured with its own node operational certificate in the ecosystem to which the mobile terminal belongs. The ecosystem is called Matter Fabric in the smart home interconnection (Matter) protocol.

In some embodiments, on the mobile terminal side, when it is determined that the security attestation is passed according to the device attestation certificate, a node operational certificate is sent to the electronic device. In response to receiving the node operational certificate from the mobile terminal, the electronic device verifies whether the node operational certificate is valid according to the root certificate. Herein, the root certificate (Root CA Certificate, CAC) is a root certificate corresponding to the ecosystem to which the mobile terminal belongs. Each ecosystem also has its corresponding root certificate, which is used to verify the identity of each node in the ecosystem, i.e., to verify the node operational certificate of each node. When it is verified that the node operational certificate is valid according to the root certificate, the electronic device installs the node operational certificate issued by the mobile terminal and configures the network, so that the electronic device and the mobile terminal are in the same network environment, and thus the electronic device joins the ecosystem to which the mobile terminal belongs.

In some embodiments, on the mobile terminal side, when it is determined that the security attestation is not passed according to the device attestation certificate, an attestation failure message is sent to the electronic device. The attestation failure message indicates that the electronic device fails the security attestation. Then, the electronic device generates and displays prompt information in response to receiving the attestation failure message. The prompt information is used to prompt the user that the electronic device fails the attestation, indicating that the user cannot control the electronic device through the mobile terminal.

The above steps S701 to S702 are executed when the mobile terminal controls the electronic device for the first time, to realize the attestation and network configuration of the electronic device, so that the electronic device joins the ecosystem to which the mobile terminal belongs. The electronic device can be in the ecosystems to which mobile terminals of different brand manufacturers belong through the above steps, so as to be controlled by mobile terminals in different ecosystems.

S703: Receiving operation information from the mobile terminal, determining a corresponding control command according to the operation information, and executing a corresponding operation according to the control command.

In some embodiments, after the electronic device performs network configuration, the electronic device is in the same network as the mobile terminal, so that the electronic device joins the ecosystem to which the mobile terminal belongs, enabling the electronic device and the mobile terminal to be in the same ecosystem. Then, the user can operate on the mobile terminal, and the mobile terminal generates operation information based on the user's operation and sends the operation information to the electronic device. In response to receiving the operation information from the mobile terminal, the electronic device determines a corresponding control command according to the operation information and executes a corresponding operation according to the control command, thereby meeting the user's demand for controlling the electronic device through the mobile terminal.

In some embodiments, the electronic device, as a node in the ecosystem, includes multiple endpoints; and each endpoint includes multiple clusters.

For case of understanding, the definitions of a node, endpoint, and cluster are introduced here: a node is generally defined as a network-addressable entity with certain functions and is unique, and both the mobile terminal and the electronic device are nodes in the ecosystem; an endpoint is a virtual device that provides one or more functions; and a cluster is a reusable module combining multiple commonly used operations.

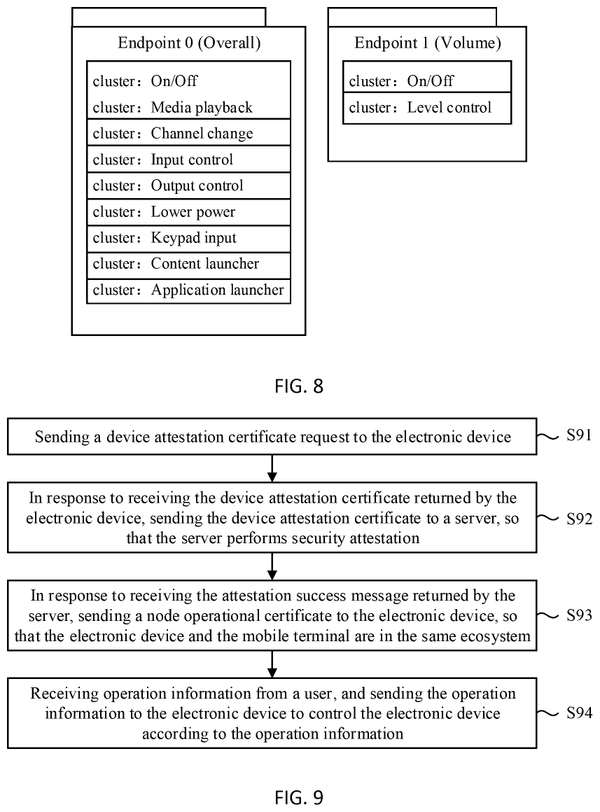

As shown in FIG. 8, which is a schematic diagram of a relationship between endpoints and clusters according to the embodiments of the present application, endpoint 0 and endpoint 1 are shown. Endpoint 0 provides the overall control function of the electronic device, and endpoint 1 provides the volume control function of the electronic device. Herein, the clusters included in endpoint 0 are: On/Off, media control (media playback), channel change, input control, output control, standby (lower power), keypad input, content launcher, and application launcher; and the clusters included in endpoint 1 are: volume switch (On/Off) and volume level control.

In the process that the electronic device determines a corresponding control command according to the operation information and executes a corresponding operation according to the control command, the electronic device first determines the cluster indicated by the operation information according to the operation information, then the protocol stack initializes the device function, and further the software development kit (SDK) calls back the operation information to the upper-layer application, so that the upper-layer application calls the business function interface to determine the control command corresponding to the operation information, thereby executing the corresponding operation.

In some embodiments, when the electronic device and the mobile terminal are in the same ecosystem, the electronic device obtains the root certificate corresponding to the ecosystem; then, in response to receiving the operation information from the mobile terminal, determines whether the operation information is from the mobile terminal in the ecosystem according to the root certificate; and when it is determined that the operation information is from the mobile terminal, determines the corresponding control command according to the operation information from the mobile terminal and executes the corresponding operation according to the control command. It should be noted that the control logic of mobile terminals in different ecosystems is different. Even if the operation information is the same, different control commands correspond to different ecosystems. Therefore, the electronic device needs to verify the identity of the mobile terminal sending the operation information according to the root certificate of the ecosystem 1 in which it is currently located. When it is determined that the mobile terminal is a node in the ecosystem 1, the electronic device determines the control command corresponding to the ecosystem according to the operation information, so that the mobile terminal can accurately control the electronic device to execute the corresponding operation.

In some embodiments, in response to receiving the node operational certificate from the mobile terminal, the electronic device installs the node operational certificate, and configures the network; and then the electronic device obtains an access control list (ACL), which includes authorized terminal information and authorized operation information corresponding to the authorized terminals. The access control list specifies the authorized operations that authorized terminals can perform on the electronic device in the ecosystem in which the electronic device is located, for example, the mobile terminal has read/write/call permissions on the electronic device. Further, after receiving the operation information from the mobile terminal, the electronic device determines whether the mobile terminal is an authorized terminal according to mobile terminal information and the authorized terminal information, and determines whether the operation information is the authorized operation information according to the operation information and the authorized operation information, so as to determine whether the mobile terminal has the permission to control the electronic device to execute the operation corresponding to the operation information through the access control list.

When it is determined that the mobile terminal is an authorized terminal and the operation information is authorized operation information, it indicates that the electronic device allows the mobile terminal to control the electronic device to execute the operation corresponding to the operation information, and then determines the corresponding control command according to the operation information, so that the electronic device executes the corresponding operation according to the control command. This achieves the purpose of the mobile terminal controlling the electronic device.

In some embodiments, after step S702 is executed, the electronic device and the mobile terminal are in the same ecosystem, and a certificate authenticated session establishment (CASE) is established between the electronic device and the mobile terminal, so that the mobile terminal encrypts the operation information and sends the encrypted operation information to the electronic device. After receiving the encrypted operation information, the electronic device verifies the validity of the operation information; and when the operation information is valid, decrypts the encrypted operation information to obtain the operation information. Further, the electronic device determines a corresponding control command according to the operation information and executes a corresponding operation according to the control command, ensuring the security of the mobile terminal controlling the electronic device. When the operation information is invalid, the electronic device returns an error code to the mobile terminal to inform the user of an operation error.

In some embodiments, after the electronic device receives the operation information from the mobile terminal, determines the corresponding control command according to the operation information and executes the corresponding operation, the electronic device feeds back the execution result of the operation information based on the CASE. Or, when the operation information is invalid, the electronic device feeds back an error code based on the CASE.

In summary, the embodiments of the present application provide a method for a mobile terminal to control an electronic device, which is applied to the electronic device. The method includes: first, in response to receiving a device attestation certificate request from the mobile terminal, sending the device attestation certificate requested by the mobile terminal to the mobile terminal, so that the mobile terminal performs security attestation based on the device attestation certificate; then, in response to receiving the node operational certificate from the mobile terminal, installing the node operational certificate and configuring the network, so that the electronic device and the mobile terminal are in the same ecosystem; and further, receiving the operation information from the mobile terminal, determining the corresponding control command according to the operation information and executing the corresponding operation according to the control command. The electronic device is not limited to being controlled by mobile terminals developed by individual or specific brand manufacturers. The electronic device can join ecosystems of different brand manufacturers, breaking through the technical barrier between different brand manufacturers, enabling various mobile terminals to control the electronic device according to unified standards, and improving the adaptability of the electronic device in controlled scenarios.

As shown in FIG. 9, which is a second flowchart of a method for a mobile terminal to control an electronic device according to the embodiments of the present application, the method is applied to the mobile terminal and includes the following steps S91 to S94.

S91: Sending a device attestation certificate request to the electronic device.

In some embodiments, before step S91 is executed, the mobile terminal performs detection through the configured communication device. In response to detecting the broadcast sent by the electronic device, the mobile terminal sends a feedback message to the electronic device, and then establishes the wireless connection with the electronic device. Herein, the communication device configured in the mobile terminal includes but is not limited to: mDNS, BLE, and NFC.

In some embodiments, after the wireless connection is established between the mobile terminal and the electronic device, a PASE is established, so that the device attestation certificate request is encrypted and sent to the electronic device based on the encryption mechanism of the PASE, so as to ensure the security of communication interaction between the mobile terminal and the electronic device.

S92: In response to receiving the device attestation certificate returned by the electronic device, sending the device attestation certificate to a server, so that the server performs security attestation.

In some embodiments, on the electronic device side, the electronic device sends the device attestation certificate to the mobile terminal in response to receiving the device attestation certificate request from the mobile terminal. After receiving the device attestation certificate, the mobile terminal forwards the device attestation certificate to the server for security attestation. The server is a DCL server. On the server side, security attestation is performed according to the received device attestation certificate to confirm whether the device attestation certificate is valid. When the device attestation certificate is valid, an attestation success message is returned to the mobile terminal. The attestation success message indicates that the electronic device passes the security attestation.

S93: In response to receiving the attestation success message returned by the server, sending a node operational certificate to the electronic device, so that the electronic device and the mobile terminal are in the same ecosystem.

In some embodiments, in response to receiving the attestation success message returned by the server, it indicates that the device attestation certificate of the electronic device is valid, so a node operational certificate is sent to the electronic device. The node operational certificate is issued by the mobile terminal. After the electronic device installs the node operational certificate, the electronic device can join the ecosystem to which the mobile terminal belongs.

S94: Receiving operation information from a user, and sending the operation information to the electronic device to control the electronic device according to the operation information.

When the user needs to control the electronic device through the mobile terminal, the user performs input on the mobile terminal, and the application does not limit the input method. The mobile terminal receives the operation information from the user and sends the operation information to the electronic device, so that the electronic device executes the corresponding operation according to the operation information, realizing the control of the electronic device through the mobile terminal.

In the above steps S91 to S94, mobile terminals in different ecosystems allow the electronic device to join ecosystems to which they belong according to a unified process; and when the electronic device and the mobile terminal are in the same ecosystem, the mobile terminal controls the electronic device to execute corresponding operations to achieve corresponding functions.

In summary, the embodiments of the present application provide a method for a mobile terminal to control an electronic device, applied to the mobile terminal. The method includes: first sending a device attestation certificate request to the electronic device, and then forwarding the device attestation certificate to a server in response to the device attestation certificate returned by the electronic device, so that the server performs security attestation; in response to receiving an attestation success message returned by the server, sending a node operational certificate to the electronic device based on that the attestation success message indicates that the security attestation is passed, to enable the electronic device to join the ecosystem to which the mobile terminal belongs according to the node operational certificate; and further, when the mobile terminal and the electronic device are in the same ecosystem, receiving operation information from the user and sending the operation information to the electronic device to control the electronic device to execute the operation corresponding to the operation information, thereby realizing the control of the electronic device through the mobile terminal.

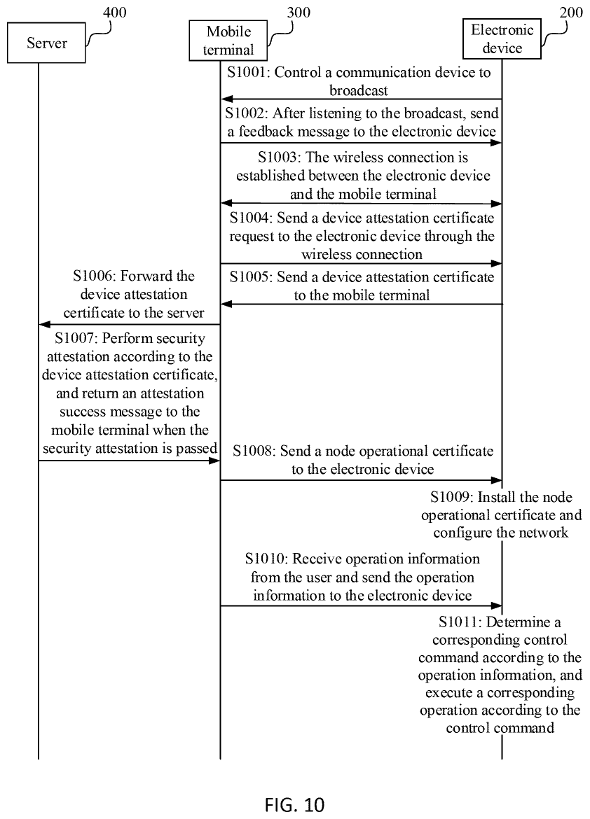

As shown in FIG. 10, which is a third flowchart of a method for a mobile terminal to control an electronic device according to the embodiments of the present application, the method is applied to an IoT system composed of a mobile terminal, an electronic device, and a server, and includes the following steps S1001 to S1011.

S1001: The electronic device controls the communication device to broadcast.

S1002: After listening to the broadcast, the mobile terminal sends a feedback message to the electronic device.

S1003: The wireless connection is established between the electronic device and the mobile terminal.

S1004: The mobile terminal sends a device attestation certificate request to the electronic device through the wireless connection.

S1005: The electronic device sends a device attestation certificate to the mobile terminal in response to the device attestation certificate request.

S1006: The mobile terminal forwards the device attestation certificate to the server.

S1007: The server performs security attestation according to the device attestation certificate, and returns an attestation success message to the mobile terminal when the security attestation is passed.

S1008: The mobile terminal sends a node operational certificate to the electronic device in response to the attestation success message.

Optionally, the above steps S1004 to S1005 and S1008 are implemented based on the PASE encryption mechanism.

S1009: The electronic device installs the node operational certificate and configures the network.

After installing the node operational certificate and configuring the network, the electronic device joins the ecosystem to which the mobile terminal belongs, so that the electronic device and the mobile terminal are in the same ecosystem.

S1010: The mobile terminal receives operation information from the user and sends the operation information to the electronic device.

S1011: The electronic device determines a corresponding control command according to the operation information, and executes a corresponding operation according to the control command.

Optionally, the above steps S1010 to S1011 are implemented based on the CASE encryption mechanism.

The implementation of the above steps is the same as or similar to that of the aforementioned steps S701 to S703 and S91 to S94, and details are not repeated herein.

In addition to the above embodiments, the present application also provides other embodiments related to the electronic device and a service control method, which are specifically described as follows.

In the Matter protocol, large-screen devices (such as televisions) are often defined as a basic video player device type for working. This type needs to support the media playback cluster. The media playback cluster requires the large-screen device to support at least the control of three playback commands: Play, Pause and Stop, and to support the acquisition of at least four playback states: Playing, Paused, Not Playing and Buffering. Since different playback contents are played by different video applications (Apps), for a large-screen device to obtain the playback states of different video applications and control the playback command for different video applications, the large-screen device needs to interface with each video application separately. Moreover, for the interface between the large-screen device and each video application, developers need to write interface docking codes to implement it.

However, the large-screen device interfaces with different video applications separately, which can increase the management complexity of interfaces on the large-screen device and the software cost.

The embodiments of the present application belong to the field of terminal interconnection, involving functions related to the Matter protocol, and provide an implementation method of the media playback cluster. Currently, most large-screen electronic devices, as the matter media playback cluster, only support playback control and playback state feedback in one way: local media playback (playback via a local video application). The embodiments of the present application provide an implementation method of the media playback cluster that can support multiple video applications.

The embodiments of the present application provide an electronic device and a service control method. The electronic device can implement the service control method according to the embodiments of the present application, or functional modules or entities in the electronic device can implement the service control method according to the embodiments of the present application. The electronic device includes at least one processor, corresponding to the at least one processor 250 in FIG. 3 above. The embodiments of the present application provide an electronic device, including: at least one processor configured to: in response to detecting a change in a playback state of the current video by a video player, obtain a target playback state of the current video through the video player; send a state message carrying the target playback state to a Matter service in the form of an Android broadcast through the video player; and receive the state message through the Matter service, and set the current state attribute of the Matter service to the target playback state.

In the embodiments of the present application, unless otherwise specified, the video player is a local player of the electronic device, that is, a player component provided by the system of the electronic device.

The target playback state includes any one of the following: Playing, Paused, Not Playing, or Buffering. It can be understood that before the playback state of the current video changes, the playback state of the current video is also one of Playing, Paused, Not Playing, or Buffering, and is different from the target playback state.

For example, the playback state may be changed from Playing to Paused (target playback state); the playback state may be changed from Not Playing to Playing (target playback state); or the playback state may be changed from Buffering to Playing (target playback state); which can be determined according to actual situations and is not limited herein.

In some embodiments of the present application, after setting the current state attribute to the target playback state, the Matter service may send a state change message to a Matter controller device. The state change message carries the target playback state. Therefore, after receiving the state change message, the Matter controller device updates the playback state stored in the Matter controller device, thereby synchronizing the playback states of the Matter service and the Matter controller device. Herein, the Matter service may send the state change message to the Matter controller device actively after the Matter service sets the current state attribute to the target playback state, or the Matter service may send the state change message to the Matter controller device in response to receiving a state acquisition command sent by the Matter controller device, which can be determined according to actual situations and is not limited herein.

It should be noted that after setting the current state attribute to the target playback state, the Matter service may or may not send the state change message to the Matter controller device, which can be determined according to actual situations and is not limited herein.

Herein, the Matter controller device may be a device installed with a Matter controller and interacting with the electronic device based on the Matter protocol through the Matter controller.

The video player may be a MediaPlayer or other players, which is not limited herein.

For example, the MediaPlayer is a player component provided by the Android system framework, and most video playback software uses this component to complete video playback. Therefore, the playback state can be obtained in the MediaPlayer. When an application calls the MediaPlayer to play a video, the MediaPlayer sends the Android broadcast for the change in states including Playing, Paused, Not Playing, and Buffering according to the change in the current playback state. The Matter service receives the broadcast and changes the attribute value of CurrentState. The specific details are as follows.

(1) When receiving a Playing broadcast sent by the MediaPlayer, the Matter service sets the attribute value of the current state attribute (CurrentState) to Playing.

(2) When receiving a Paused broadcast sent by the MediaPlayer, the Matter service sets the attribute value of CurrentState to Paused.

(3) When receiving a Not Playing broadcast sent by the MediaPlayer, the Matter service sets the attribute value of CurrentState to Not Playing.

(4) When receiving a Buffering broadcast sent by the MediaPlayer, the Matter service sets the attribute value of CurrentState to Buffering.

In this way, when a video application uses the MediaPlayer for playback, there is no need for interface docking, and the corresponding playback state can be obtained and set in the Matter protocol service by sending an Android broadcast. Thus, the method based on the Android broadcast provides a method for obtaining playback states that can support multiple video applications. As a large-screen device, the electronic device can obtain playback states without interfacing with each video application separately, which greatly reduces the management complexity of interfaces on the large-screen device and the software cost. In some embodiments of the present application, the reason for the change in the playback state may be that the electronic device switches the playback state of the current video in response to receiving a key operation (such as a key operation on a remote control) or a touch operation on the electronic device from the user; or that the electronic device switches the playback state of the current video in response to receiving a control command sent by the Matter controller device; or that the electronic device changes the current video from Playing to Not Playing in response to detecting that the current video playback ends or an error occurs during playback; or other reasons, which can be determined according to actual situations and are not limited herein.

In some embodiments of the present application, when the reason for the change in the playback state is that the electronic device switches the playback state of the current video in response to receiving a control command sent by the Matter controller device, the at least one processor is further configured to: based on that a change in the playback state of the current video is detected by the video player, before obtaining the target playback state of the current video through the video player, receive, by the Matter service, a target control command for a target video application sent by the Matter controller device; generate, by the Matter service, a target key event corresponding to the target control command; call, by the Matter service, a target system interface to issue the target key event to a target system layer; and send, by the target system layer, the target key event to the target video application, so that the target video application controls the video player to execute the target control command based on the target key event.

Herein, the target control command includes any one of the following: Play, Pause, and Stop.

It can be understood that if the target control command is Play, the target key event is a Play key event, and the target playback state is Playing or Buffering, then the change in the playback state is a change from another playback state to Playing or Buffering. If the target control command is Pause, the target key event is a Pause key event, and the target playback state is Paused, then the change in the playback state is a change from another playback state to Paused. If the target control command is Stop, the target key event is a Stop key event, and the target playback state is Not Playing, then the change in the playback state is a change from another playback state to Not Playing.

It can be understood that in the embodiments of the present application, the Matter service simulates the target key event corresponding to the target control command, and then issues the generated target key event to the target system layer through the target system interface; and then the target system layer issues the target key event to the video player, thereby enabling the video player to execute the target control command based on the target key event. In this way, the process of simulating the target key event corresponding to the target control command through the Matter service and reusing the target system interface to issue the target key event to the video player enables the electronic device, as the Media Playback Cluster, to support at least the control of the three playback commands: Play, Pause, and Stop. As a large-screen device, the electronic device can control playback commands without interfacing with each video application separately, which greatly reduces the management complexity of interfaces on the large-screen device and the software cost.

In some embodiments of the present application, when the target system layer is an Android framework layer, the target system interface is an interface corresponding to the Android framework layer.

For example, the interface corresponding to the Android framework layer may be the android.app.Instrumentation interface.

In some embodiments of the present application, when the target system layer is a kernel layer, the target system interface is an interface corresponding to the kernel layer.

For example, the kernel layer may be a Linux kernel layer, and the interface corresponding to the Linux kernel layer is a uinput interface.

In some embodiments of the present application, when the target system layer is a driver layer, the target system interface is an interface corresponding to the driver layer.

For example, the interface corresponding to the driver layer is the/dev/input/eventX interface.

In some embodiments of the present application, the target key event includes a target key press event corresponding to the target control command and a target key up event corresponding to the target control command. The at least one processor is specifically configured to: generate the target key press event through the Matter service; call a target system interface through the Matter service to issue the target key press event to the target system layer; send the target key press event to the target video application through the target system layer; after a preset duration, generate the target key up event through the Matter service; call a target system interface through the Matter service to issue the target key up event to the target system layer; and send the target key up event to the target video application through the target system layer, so that the target video application controls the video player to execute the target control command based on the target key press event and the target key up event.

Herein, the preset duration can be determined according to actual situations and is not limited herein. For example, the preset duration can be 100 ms.

For example, the Matter service starts the Matter protocol stack and listens for control commands received on the network port and issued by the Matter controller device. The Android system defines keys for Play, Pause, and Stop. After receiving the control command, the Matter service issues a key event to the Android framework key module. The Android system automatically distributes it to the foreground video application for response. The process is as follows.

(1) In response to receiving a Play command, the Media Playback Cluster of the Matter first issues a Play key press event to the Android framework key module; and after waiting for a short period of time (e.g., 100 ms), issues a Play key up event to the Android framework key module to simulate the process of pressing the Play key. Specifically, a KeyEvent representing the Play key press event can be created using KeyEvent.ACTION_DOWN and the key value KeyEvent.KEYCODE_MEDIA_PLAY, and then the KeyEvent representing the Play key press event is issued to the Android framework using the android.app.Instrumentation.sendKeySync( ) interface. After waiting for 100 ms, a KeyEvent representing the Play key up event is created using KeyEvent.ACTION_UP and the key value KeyEvent.KEYCODE_MEDIA_PLAY, and then the KeyEvent representing the Play key up event is issued to the Android framework using the android.app.Instrumentation.sendKeySync( ) interface.

(2) In response to receiving a Pause command, the Media Playback Cluster of the Matter first issues a Pause key press event to the Android framework key module; and after waiting for a short period of time (e.g., 100 ms), issues a Pause key up event to the Android framework key module to simulate the process of pressing the Pause key. Specifically, a KeyEvent representing the Pause key press event can be created using KeyEvent.ACTION_DOWN and the key value KeyEvent.KEYCODE_MEDIA_PAUSE, and then the KeyEvent representing the Pause key press event is issued to the Android framework using the android.app.Instrumentation.sendKeySync( ) interface. After waiting for 100 ms, a KeyEvent representing the Pause key up event is created using KeyEvent.ACTION_UP and the key value KeyEvent.KEYCODE_MEDIA_PAUSE, and then the KeyEvent representing the Pause key up event is issued to the Android framework using the android.app.Instrumentation.sendKeySync( ) interface.

(3) In response to receiving a Stop command, the Media Playback Cluster of the Matter first issues a Stop key press event to the Android framework key module; and after waiting for a short period of time (e.g., 100 ms), issues a Stop key up event to the Android framework key module to simulate the process of pressing the Stop key. Specifically, a KeyEvent representing the Stop key press event can be created using KeyEvent.ACTION_DOWN and the key value KeyEvent.KEYCODE_MEDIA_STOP, and then the KeyEvent representing the Stop key press event is issued to the Android framework using the android.app.Instrumentation.sendKeySync( ) interface. After waiting for 100 ms, a KeyEvent representing the Stop key up event is created using KeyEvent.ACTION_UP and the key value KeyEvent.KEYCODE_MEDIA_STOP, and then the KeyEvent representing the Stop key up event is issued to the Android framework using the android.app.Instrumentation.sendKeySync( ) interface.

The video application needs to listen for and process corresponding key events on the playback interface to control the player to perform Play, Pause, and Stop operations.

Herein, the way of calling the android.app.Instrumentation interface is only one way to simulate keys in the Android system, and other simulation methods can also achieve this function.

For example, the Matter service starts the Matter protocol stack and listens for control commands received on the network port and issued by the Matter controller device. The Android system defines keys for Play, Pause, and Stop. Taking the uinput interface provided by the Linux kernel as an example: when the Matter service starts, the uinput descriptor is initialized. Taking the Android system as an example, the specific process is to first use an open function to open the “/dev/uinput” file, and then use ioctl to create a virtual input device and initialize the keys corresponding to Play, Pause, and Stop. In this case, keys simulation can be performed. The specific process can be as follows.

In response to receiving a Play command, the Media Playback Cluster of the Matter creates an input_event structure; set its type to EV_KEY, code to KEY_PLAY, and value to 1 (representing a press); and uses a write function to write to the opened uinput file descriptor. Then, the Media Playback Cluster of the Matter creates another input_event structure; sets its type to EV_SYNC, code to SYNC_REPORT, and value to 0; and uses a write function to write to the opened uinput file descriptor to simulate the Play key press event. After waiting for 100 ms, the Media Playback Cluster of the Matter creates an input_event structure; set its type to EV_KEY, code to KEY_PLAY, and value to −1 (representing the key up); and uses a write function to write to the opened uinput file descriptor. Then, the Media Playback Cluster of the Matter creates another input_event structure; sets its type to EV_SYNC, code to SYNC_REPORT, and value to 0; and uses a write function to write to the opened uinput file descriptor to simulate the Play key up event.

The key simulation processes for Stop and Pause are consistent with the above process, except that the key values to be simulated are KEY_STOP and KEY_PAUSE respectively, which will not be repeated. The video application needs to listen for and process corresponding key events on the playback interface to control the player to perform Play, Pause, and Stop operations.

For example, the Matter service starts the Matter protocol stack and listens for control commands received on the network port and issued by the Matter controller device. The Android system defines keys for Play, Pause, and Stop. Key simulation can also be performed by adding input nodes in the driver layer. For example, an input node such as “/dev/input/eventX” can be registered in the driver layer by inserting a kernel module. In response to receiving a Play command, the Media Playback Cluster of the Matter can write a KEY_PLAY press event to the driver node, and then after waiting for 100 ms, write a KEY_PLAY up event to the driver node to realize the simulated input of the Play key. In response to receiving a Pause command, the Media Playback Cluster of the Matter can write a KEY_Pause press event to the driver node, and then after waiting for 100 ms, write a KEY_Pause up event to the driver node to realize the simulated input of the Pause key. In response to receiving a Stop command, the Media Playback Cluster of the Matter can write a KEY_Stop press event to the driver node, and then after waiting for 100 ms, write a KEY_Stop up event to the driver node to realize the simulated input of the Stop key. The process of implementing key simulation in the driver layer can refer to related technologies and will not be elaborated here.

In the embodiments of the present application, the Matter service realizes the final simulation of the target key event by generating the press event of the target key and the up event of the target key.

In some embodiments of the present application, when the reason for the change in the playback state is that the electronic device switches the playback state of the current video in response to receiving a control command sent by the Matter controller device, the at least one processor is further configured to: receive a target control command for a target video application sent by the Matter controller device through the Matter service; and send a command message carrying the target control command to the target video application in the form of an Android broadcast through the Matter service, so that the target video application controls the video player to execute the target control command after receiving the command message.

Herein, the target control command includes any one of the following: Play, Pause, and Stop.

In the embodiments of the present application, without interface docking, the electronic device, as the Media Playback Cluster, can support at least the control of three playback commands, i.e., Play, Pause and Stop, by sending Android broadcasts to the video application. In this way, the electronic device, as a large-screen device, can control playback commands without interfacing with each video application separately, which greatly reduces the management complexity of interfaces on the large-screen device and the software cost.

In some embodiments of the present application, when the target video application does not use the local video player of the electronic device for playback but uses a target player corresponding to the target video application, the video application can obtain the target playback state of the target player in response to the video application detecting a change in the playback state of the target player (the playback state of the current played video); then the target video application sends a state message carrying the target playback state to the Matter service in the form of an Android broadcast; and the state message is received through the Matter service and the current state attribute of the Matter service is set to the target playback state. For the command control, reference can be made to the above description.

The embodiments of the present application provide an electronic device, including: at least one processor configured to: in response to detecting a change in the playback state of the current video by the video player, obtain the target playback state of the current video through the video player; store the target playback state in a preset storage area; obtain the target playback state from the preset storage area through the Matter service; and set the current state attribute of the Matter service to the target playback state.

Herein, the target playback state includes any one of the following: Playing, Paused, Not Playing, and Buffering. It can be understood that before the playback state of the current video changes, the playback state of the current video is also one of Playing, Paused, Not Playing or Buffering, and is different from the target playback state.

Herein, the preset storage area may be a database-type storage area, a file-type storage area, or a memory variable-type storage area, which can be determined according to actual situations and is not limited herein.

In the embodiments of the present application, a method for obtaining playback states that can support multiple video applications is provided by setting a preset storage area. As a large-screen device, the electronic device can obtain playback states without interfacing with each video application separately, which greatly reduces the management complexity of interfaces on the large-screen device and the software cost.

In some embodiments of the present application, the reason for the change in the playback state may be that the electronic device switches the playback state of the current video in response to receiving a key operation (such as a key operation on a remote control) or a touch operation on the electronic device from the user; or that the electronic device switches the playback state of the current video in response to receiving a control command sent by the Matter controller device; or that the electronic device changes the current video from Playing to Not Playing in response to detecting that the current video playback ends or an error occurs during playback; or other reasons, which can be determined according to actual situations and are not limited herein.

In some embodiments of the present application, when the reason for the change in the playback state is that the electronic device switches the playback state of the current video in response to receiving a control command sent by the Matter controller device, the at least one processor is further configured to: receive a target control command for a target video application sent by the Matter controller device through the Matter service, where the target control command includes any one of the following: a play command, a pause command, and a stop command; generate a target key event corresponding to the target control command through the Matter service; call a target system interface through the Matter service to issue the target key event to a target system layer; and send the target key event to the target video application through the target system layer, so that the target video application controls the video player to execute the target control command based on the target key event. For the specific description, reference can be made to the above related description, and details are not repeated herein.

In some embodiments of the present application, when the target system layer is an Android framework layer, the target system interface is an interface corresponding to the Android framework layer. When the target system layer is a kernel layer, the target system interface is an interface corresponding to the kernel layer. When the target system layer is a driver layer, the target system interface is an interface corresponding to the driver layer. For the specific description, reference can be made to the above related description, and details are not repeated herein.

In some embodiments of the present application, the target key event includes a target key press event corresponding to the target control command and a target key up event corresponding to the target control command. The at least one processor is specifically configured to: generate the target key press event through the Matter service; call a target system interface through the Matter service to issue the target key press event to the target system layer; send the target key press event to the target video application through the target system layer; after a preset duration, generate the target key up event through the Matter service; call a target system interface through the Matter service to issue the target key up event to the target system layer; and send the target key up event to the target video application through the target system layer, so that the target video application controls the video player to execute the target control command based on the target key press event and the target key up event. For the specific description, reference can be made to the above related description, and details are not repeated herein.

In some embodiments of the present application, when the reason for the change in the playback state is that the electronic device switches the playback state of the current video in response to receiving a control command sent by the Matter controller device, the at least one processor is further configured to: receive a target control command for a target video application sent by the Matter controller device through the Matter service; and send a command message carrying the target control command to the target video application in the form of an Android broadcast through the Matter service, so that the target video application controls the video player to execute the target control command after receiving the command message. For the specific description, reference can be made to the above related description, and details are not repeated herein.

Referring to FIG. 4, in some embodiments, at least one application runs in the application layer. These applications may be window programs, system setting programs, or clock programs that are native to the operating system; or may also be applications developed by third-party developers. In specific implementation, the application packages in the application layer are not limited to the above examples.

The framework layer provides an application programming interface (API) and a programming framework for applications. The application framework layer includes some predefined functions. The application framework layer is equivalent to a processing center, which determines the actions to be made by applications in the application layer. Through the API interface, applications can access resources in the system and obtain system services during execution.

As shown in FIG. 4, the application framework layer in the embodiments of the present application includes managers, content providers, etc. Herein, the managers include at least one of the following modules: an activity manager for interacting with all running activities in the system; a location manager for providing access to the system location service for the system services or applications; a package manager for retrieving various information related to application packages currently installed on the device; a notification manager for controlling the display and clearing of notification messages; and a window manager for managing icons, windows, toolbars, wallpapers, and desktop widgets on the user interface.

In some embodiments, the activity manager is configured to manage the lifecycle of each application and general navigation back functions, such as controlling the exit, opening, and back of applications. The Window Manager is configured to manage all window programs, such as obtaining a size of the display screen, determining whether there is a status bar, locking the screen, capturing the screen, and controlling changes in the display window (such as reducing the display window, jiggling the display window, distorting the display window for display, etc.).

In some embodiments, the system runtime library layer provides support for the upper layer, i.e., the framework layer. When the framework layer is used, the Android operating system runs the C/C++ libraries included in the system runtime library layer to implement the functions to be achieved by the framework layer.

In some embodiments, the kernel layer is a layer between hardware and software. As shown in FIG. 4, the kernel layer includes a driver layer, which contains at least one of the following drivers: an audio driver, a display driver, a Bluetooth driver, a camera driver, a WIFI driver, a universal serial bus (USB) driver, a high-definition multimedia interface (HDMI) driver, a sensor driver (such as a fingerprint sensor, a temperature sensor, a pressure sensor, etc.), and a power driver.

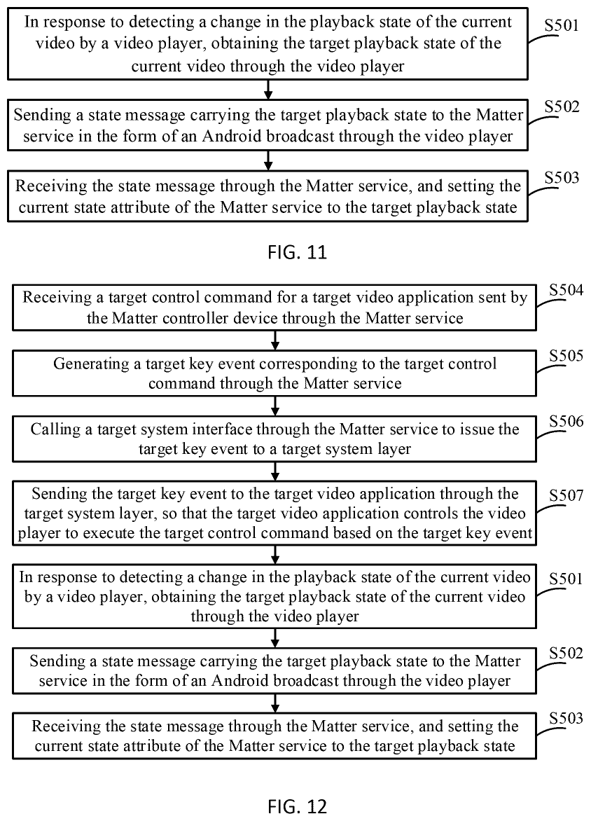

To explain the solution in more detail, the following description will be given by way of examples in conjunction with FIGS. 11 to 18. It should be understood that steps involved in FIGS. 11 to 18 may include more or fewer steps in actual implementation, and the order of these steps may also vary, whichever is capable of realizing the service control method provided in the embodiments of the present application. The service control method is applied to an electronic device. The execution subject of the service control method may be the electronic device, or a functional module or entity in the electronic device that can implement the service control method, which is not limited herein. Moreover, for the specific description of the service control method provided by the embodiments of the present application, reference can be made to the related description of the above electronic device, and the same or similar technical effects can be achieved, which is not repeated herein.

FIG. 11 is a flowchart of steps for implementing a service control method according to one or more embodiments of the present application. The service control method may include S501 to S503.

S501: In response to detecting a change in the playback state of the current video by a video player, obtaining the target playback state of the current video through the video player.

S502: Sending a state message carrying the target playback state to the Matter service in the form of an Android broadcast through the video player.

S503: Receiving the state message through the Matter service, and setting the current state attribute of the Matter service to the target playback state.

In some embodiments of the present application, in combination with FIG. 11, as shown in FIG. 12, before S501, the service control method provided by the embodiments of the present application may further include S504 to S507 described below.

S504: Receiving a target control command for a target video application sent by the Matter controller device through the Matter service.

S505: Generating a target key event corresponding to the target control command through the Matter service.

S506: Calling a target system interface through the Matter service to issue the target key event to a target system layer.

S507: Sending the target key event to the target video application through the target system layer, so that the target video application controls the video player to execute the target control command based on the target key event.

In some embodiments of the present application, when the target system layer is an Android framework layer, the target system interface is an interface corresponding to the Android framework layer. When the target system layer is a kernel layer, the target system interface is an interface corresponding to the kernel layer. When the target system layer is a driver layer, the target system interface is an interface corresponding to the driver layer.

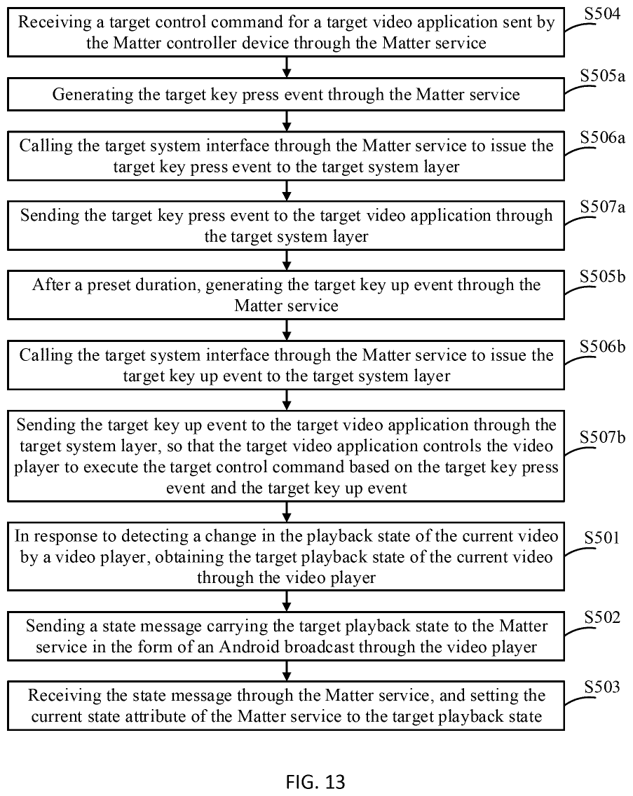

In some embodiments of the present application, the target key event includes a target key press event corresponding to the target control command and a target key up event corresponding to the target control command. In combination with FIG. 12, as shown in FIG. 13, the above S505 can be specifically implemented through S505a and S505b described below; the above S506 can be specifically implemented through S506a and S506b described below; and the above S507 can be specifically implemented through S507a and S507b described below.

S505a: Generating the target key press event through the Matter service.

S506a: Calling the target system interface through the Matter service to issue the target key press event to the target system layer.

S507a: Sending the target key press event to the target video application through the target system layer.

S505b: After a preset duration, generating the target key up event through the Matter service.

S506b: Calling the target system interface through the Matter service to issue the target key up event to the target system layer.

S507b: Sending the target key up event to the target video application through the target system layer, so that the target video application controls the video player to execute the target control command based on the target key press event and the target key up event.

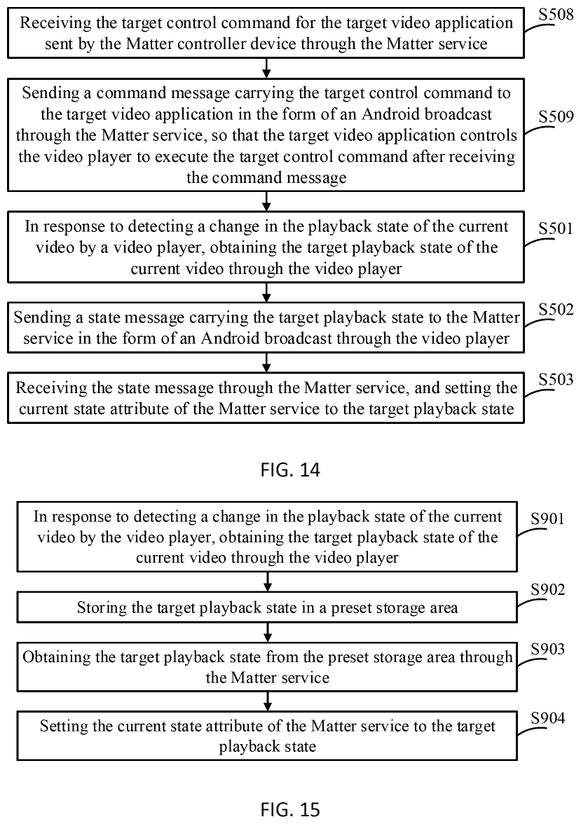

In some embodiments of the present application, in combination with FIG. 11, as shown in FIG. 14, before S501, the service control method provided by the embodiments of the present application may further include S508 to S509 described below.

S508: Receiving the target control command for the target video application sent by the Matter controller device through the Matter service.

S509: Sending a command message carrying the target control command to the target video application in the form of an Android broadcast through the Matter service, so that the target video application controls the video player to execute the target control command after receiving the command message.

FIG. 15 is a flowchart of steps for implementing a service control method according to one or more embodiments of the present application. The service control method may include S901 to S904.

S901: In response to detecting a change in the playback state of the current video by the video player, obtaining the target playback state of the current video through the video player. S902: Storing the target playback state in a preset storage area.

S903: Obtaining the target playback state from the preset storage area through the Matter service.

S904: Setting the current state attribute of the Matter service to the target playback state.

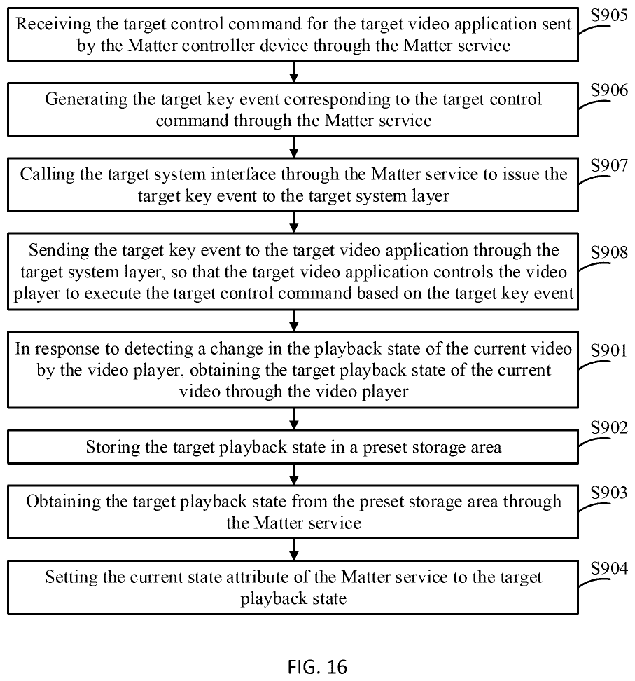

In some embodiments of the present application, in combination with FIG. 15, as shown in FIG. 16, before S901, the service control method provided by the embodiments of the present application may further include S905 to S908 described below.

S905: Receiving the target control command for the target video application sent by the Matter controller device through the Matter service.

S906: Generating the target key event corresponding to the target control command through the Matter service.

S907: Calling the target system interface through the Matter service to issue the target key event to the target system layer.

S908: Sending the target key event to the target video application through the target system layer, so that the target video application controls the video player to execute the target control command based on the target key event.

In some embodiments of the present application, when the target system layer is an Android framework layer, the target system interface is an interface corresponding to the Android framework layer. When the target system layer is a kernel layer, the target system interface is an interface corresponding to the kernel layer. When the target system layer is a driver layer, the target system interface is an interface corresponding to the driver layer.

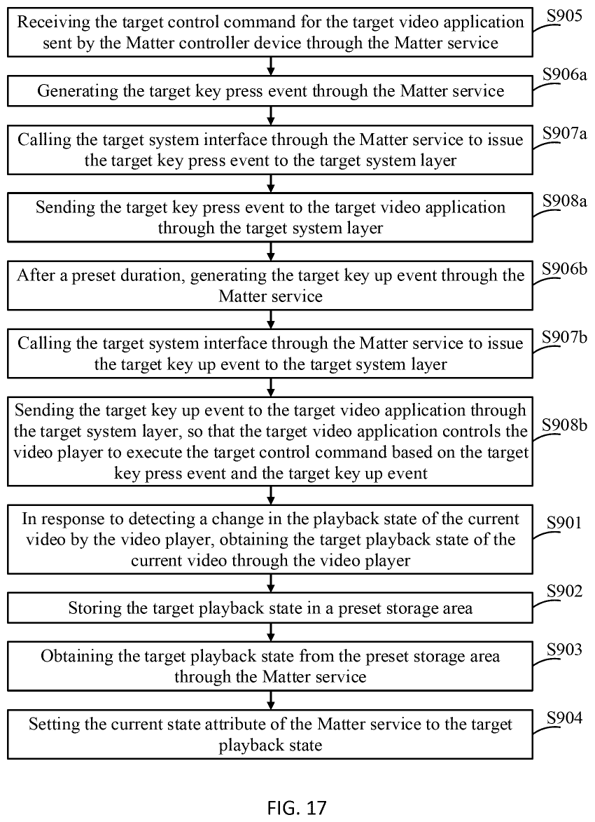

In some embodiments of the present application, the target key event includes the target key press event corresponding to the target control command and the target key up event corresponding to the target control command. In combination with FIG. 16, as shown in FIG. 17, the above S906 can be specifically implemented through S906a and S906b described below; the above S907 can be specifically implemented through S907a and S907b described below; and the above S908 can be specifically implemented through S908a and S908b described below. S906a: Generating the target key press event through the Matter service.

S907a: Calling the target system interface through the Matter service to issue the target key press event to the target system layer.

S908a: Sending the target key press event to the target video application through the target system layer.

S906b: After a preset duration, generating the target key up event through the Matter service.

S907b: Calling the target system interface through the Matter service to issue the target key up event to the target system layer.

S908b: Sending the target key up event to the target video application through the target system layer, so that the target video application controls the video player to execute the target control command based on the target key press event and the target key up event.

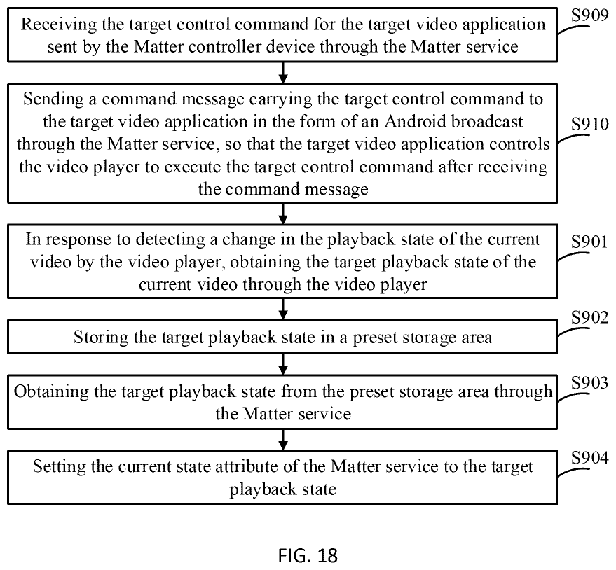

In some embodiments of the present application, in combination with FIG. 15, as shown in FIG. 18, before S901, the service control method provided by the embodiments of the present application may further include S909 to S910 described below.

S909: Receiving the target control command for the target video application sent by the Matter controller device through the Matter service.

S910: Sending a command message carrying the target control command to the target video application in the form of an Android broadcast through the Matter service, so that the target video application controls the video player to execute the target control command after receiving the command message.

In addition to the above embodiments, the present application also provides other embodiments related to a device information management method and a device attestation method for a controlled device and a master device, which are specifically described as follows.

The Matter standard is an open source standard for smart homes, and is formulated, certified and promoted by the Connectivity Standards Alliance. The Matter standard is based on the Internet protocol (IP); and smart home devices, mobile applications, and cloud services that comply with the Matter standard can perform interconnection and communication. A master device can configure the network for a controlled device based on the Matter standard to add the controlled device to the Matter network of the master device, i.e., a virtual domain. After the controlled device is added to the virtual domain of the master device, the master device has the control permission over the controlled device.

The master device and the controlled device provided in the embodiments of the present application can have various implementation forms. For example, the master device and the controlled device can be electronic devices or non-electronic devices, may or mot not have Bluetooth functions, may or mot not have cameras, and may be position-fixed devices or movable devices. A distance between the master device and the controlled device and a spatial range in which the master device and the controlled device are located are not limited. For example, the distance between the master device and the controlled device may be more than 10 meters, or the master device and the controlled device may be in different rooms, etc.

In some embodiments, if the master device and the controlled device are electronic devices, the electronic devices can be implemented in various forms, such as smart televisions (TVs), laser projection devices, monitors, electronic bulletin boards, electronic tables, or devices with a display screen such as a mobile phone, a tablet computer, and a smart watch.

In some embodiments, if the master device and the controlled device are non-electronic devices, the non-electronic devices can be implemented in various forms, such as smart lights, smart refrigerators, smart kitchenware, smart bathroom fixtures, smart air conditioners, smart speakers without display screens, etc. Non-electronic devices can establish transmission and reception of control signals and data signals with other devices, such as a third-party device, the master device, or the controlled device, through the communication device.

In the embodiments of the present application, the process of the master device configuring the network for the controlled device refers to adding the controlled device to the Matter network of the master device. The Matter network can be a virtual domain (Fabric). The master device has a corresponding virtual domain, which includes the master device and all controlled devices controlled by the master device. The master device and controlled devices belonging to the same virtual domain access the same local area network (i.e., a specified network). The device in a virtual domain uses a node operational certificate (NOC) that the device holds to identify the virtual domain it belongs and its identity within the virtual domain. After the master device configures the network for the controlled device, the master device assigns an NOC certificate to the controlled device to mark the addition of the controlled device to its own virtual domain. The NOC certificate held by each device in the virtual domain includes: a virtual domain identifier for uniquely identifying the virtual domain, such as a Fabric ID, and a node identifier for uniquely identifying the device in the virtual domain, such as a Node ID. That is, virtual domains of different master devices have different Fabric IDs; Node IDs of devices in the same virtual domain are different, but Node IDs of devices in different virtual domains can be the same. A local area network can include one or more virtual domains, and there can be overlaps between the virtual domains.

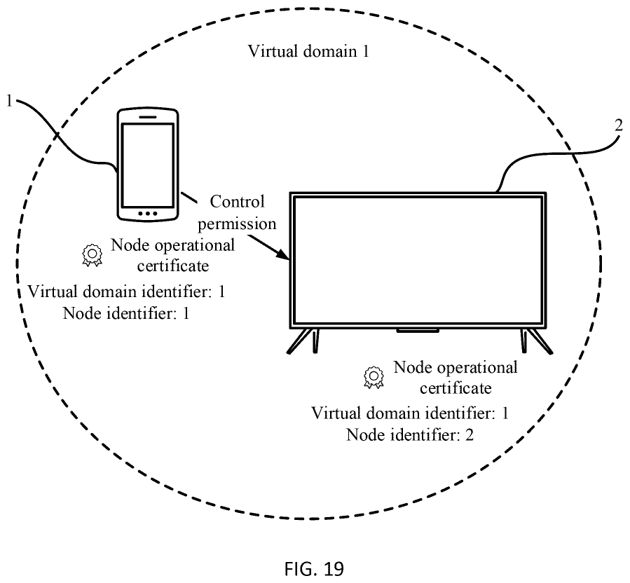

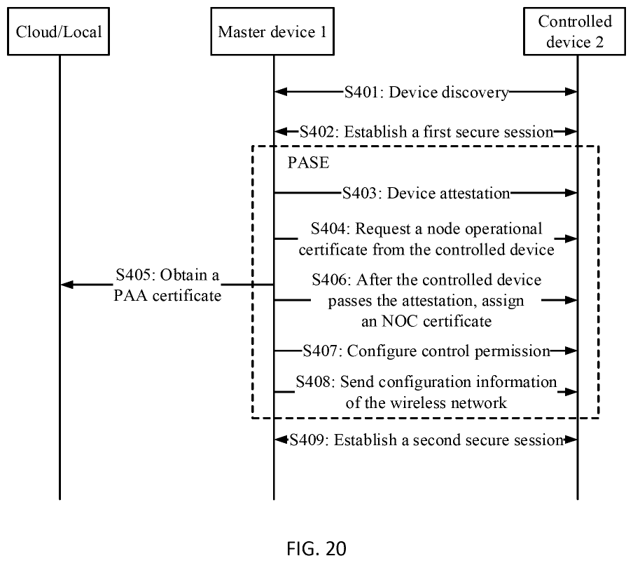

During network configuration, the master device acts as a network configuration device, and the controlled device acts as a network access device. FIG. 19 is a schematic diagram of a scenario where a master device configures a network for a controlled device according to the embodiments of the present application. As shown in FIG. 19, the master device 1 configures the network for the controlled device 2. The master device 1 can configure the network for the controlled device 2 according to the process shown in FIG. 20, with specific steps as follows.

Step S401: the master device 1 and the controlled device 2 perform device discovery.

When the master device 1 configures the network for the controlled device 2, device discovery is performed based on a device discovery protocol, such as a multicast domain name system (mDNS) protocol. Or, the master device 1 can quickly perform device discovery by scanning the QR code of the controlled device 2, entering the pairing code provided by the controlled device 2, or communicating with the controlled device 2 via near field communication (NFC).

Step S402: the master device 1 and the controlled device 2 establish a first secure session.

After discovering the controlled device 2, the master device 1 establishes a first connection with the controlled device 2, where the first connection is a Bluetooth connection; and obtains a passcode provided by the controlled device 2. Based on the first connection, the master device 1 and the controlled device 2 establish the first secure session, such as a PASE session, according to the passcode.

Based on the first secure session, the master device 1 and the controlled device 2 perform the following interactions.

Step S403: the master device 1 and the controlled device 2 perform device attestation.

Step S404: the master device 1 requests a node operational certificate (operational certificate signing request, Op-CSR) from the controlled device 2.

Step S405: the master device 1 obtains a product attestation authority (PAA) certificate from the cloud or locally.

Step S406: after the controlled device 2 passes the attestation, the master device 1 assigns an NOC certificate to the controlled device 2.

Step S407: the master device 1 configures the control permission for the controlled device 2.

For example, the master device 1 sends device information, including the control permission, to the controlled device 2, so that the controlled device 2 stores the device information of the master device 1 in an access control list (ACL) to manage the master device 1 through the ACL.

Step S408: the master device 1 sends configuration information of the wireless network to the controlled device 2.

The master device 1 sends configuration information of the wireless network to the controlled device 2 and instructs the controlled device 2 to join the wireless network.

Step S409: the master device 1 and the controlled device 2 establish a second secure session.

After the controlled device 1 joins the wireless network, the master device 1 and the controlled device 2 can establish a second connection based on the wireless network. The second connection is a Wi-Fi connection. Based on the second connection, the master device 1 and the controlled device 2 can establish the second secure session, such as a CASE session, according to their respective NOC certificates to transmit commands and data through the second secure session.

Through the above process, the master device 1 completes network configuration for the controlled device 2. As shown in FIG. 19, the controlled device 2 joins the virtual domain of the master device 1, such as Fabric 1. The NOC certificate held by the master device 1 includes the Node ID of the master device 1 in Fabric 1, such as Node ID: 1. The NOC certificate held by the controlled device 2 includes the Node ID of the controlled device 2 in Fabric 1, such as Node ID: 2. The master device 1 can control the controlled device 2 and transmit data with the controlled device 2.

In step S403, the master device 1 requests the controlled device 2 to provide attestation data for device attestation based on the attestation data. In response to the request, the controlled device 2 returns signed data to the master device 1. The signed data includes attestation data and a signature. The signature is used for the master device 1 verifying the identity of the device from which the attestation data originates, and the signature is obtained by the controlled device 2 signing the attestation data with a private key. Thus, the private key of the controlled device 2 is crucial to ensuring the validity of the signature.

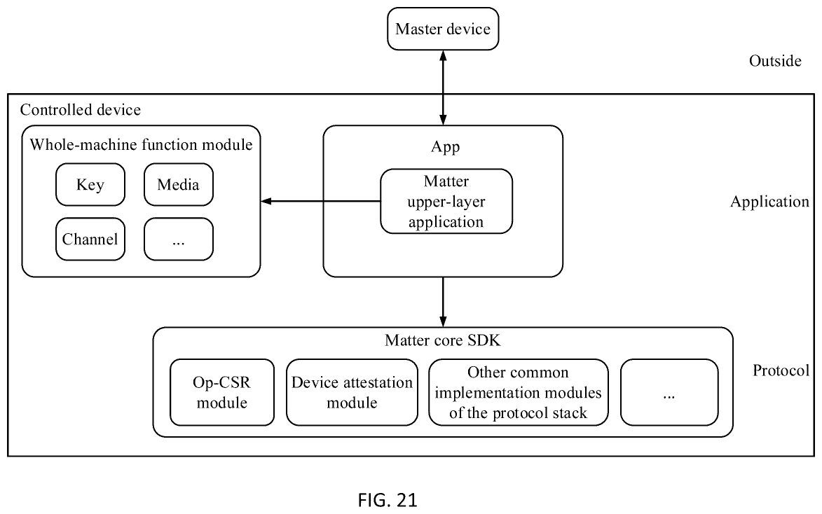

The permanent identity of each Matter device (including the master device 1 and the controlled device 2) is based on a pair of public key and private key, which are unique to each Matter device. FIG. 21 shows the system architecture of the controlled device 2 implementing the Matter service. As shown in FIG. 21, the Matter protocol stack integrates software development kits (SDKs), such as an Op-CSR module, a device attestation module and other common implementation modules of the protocol stack, into the upper-layer application of the Matter-controlled device. Users can control the switch of the Matter service through the visual page of the upper-layer application and implement corresponding functions through whole-machine function modules, such as a key module, a media module, and a channel module. Based on the system architecture shown in FIG. 21, the storage security of the private key cannot be guaranteed, and the security of the private key during use cannot be guaranteed, thus failing to ensure the validity of the signature and the accuracy of subsequent verification of the identity of the controlled device. To solve the above problem, the controlled device 2 in the embodiments of the present application is configured to support a rich execution environment (REE) and a trusted execution environment (TEE). REE is the common execution environment for all devices, running a general operating system (OS), such as Android or iOS. TEE is usually used for digital rights management (DRM), mobile payment, and sensitive data protection, with high security. The TEE stores the private key of the controlled device 2 and does not provide the private key to the outside, such as not exposing interfaces to the outside, so that other applications running outside the TEE cannot call the private key. Thus, the storage security of the private key can be guaranteed.

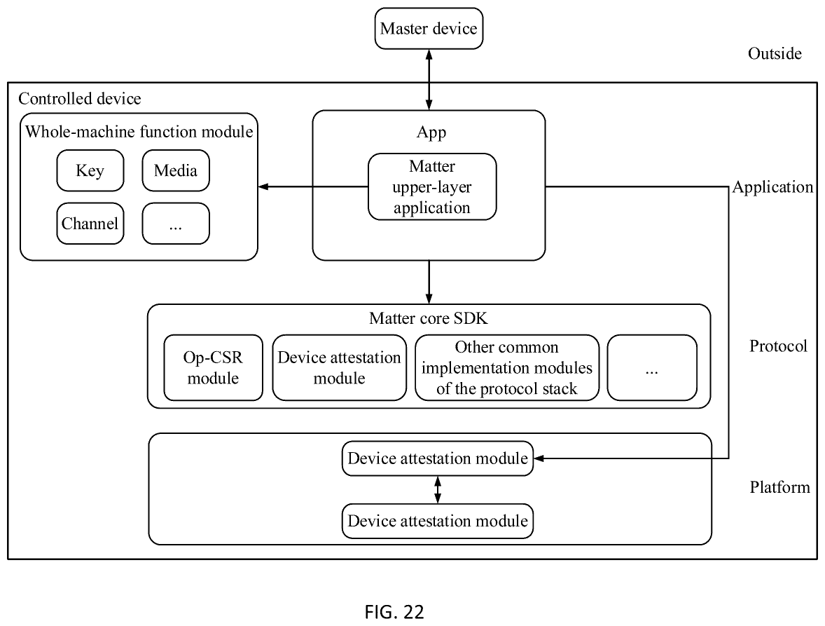

The embodiments of the present application provide a system architecture for a controlled device to implement the Matter service as shown in FIG. 22. Compared with the system architecture shown in FIG. 21, the system architecture shown in FIG. 22 integrates a client application (Client App, CA) and a trusted application (Trusted App, TA) in the platform layer. The CA application belongs to an application in the REE, the TA application belongs to an application in the TEE, and the TA can store the private key of the controlled device 2.

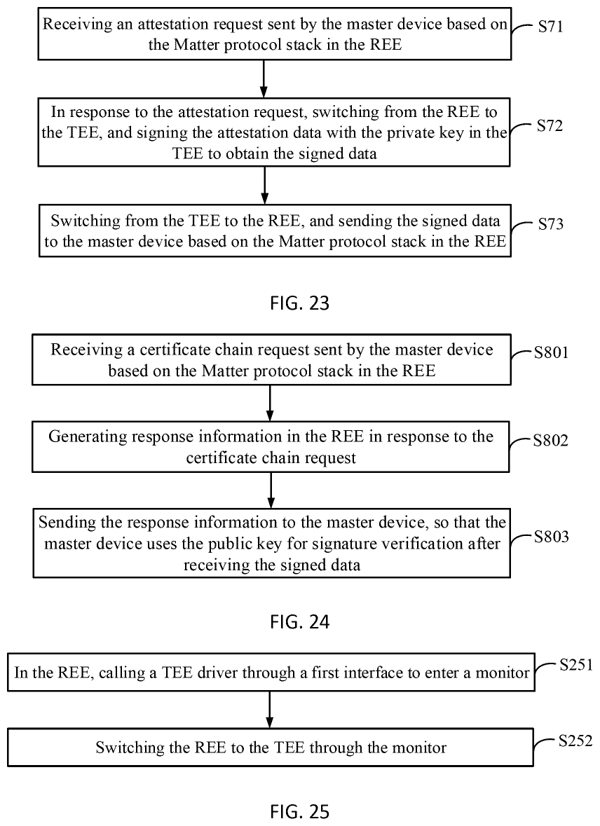

Based on the system architecture shown in FIG. 22, the embodiments of the present application also provide a device attestation method. The controlled device can perform device attestation with the master device according to the process shown in FIG. 23, with specific steps as follows.

S71: Receiving an attestation request sent by the master device based on the Matter protocol stack in the REE.

Before step S71, the controlled device establishes the first secure session with the master device in response to the network configuration request of the master device, which can refer to steps S401-S402 and will not be repeated here. Based on the first secure session, the controlled device and the master device perform the device attestation process.

The data required for device attestation between the controlled device and the master device includes the certificate chain of the controlled device and the attestation data provided by the controlled device.

In some embodiments, if the master device already has the certificate chain of the controlled device, there is no need to request the certificate chain from the controlled device again.

In other embodiments, if the master device does not have the certificate chain of the controlled device, the controlled device can exchange the certificate chain with the master device according to the process shown in FIG. 24, with specific steps as follows.

S801: Receiving a certificate chain request sent by the master device based on the Matter protocol stack in the REE.

The certificate chain request is used to request the certificate chain of the controlled device, and the master device can read the certificate chain of the controlled device using the name CertificateChainRequest. The certificate chain includes a product attestation intermediate (PAI) certificate and a device attestation certificate (DAC). Therefore, the master device usually needs to obtain the above two certificates through two commands respectively.

S802: Generating response information in the REE in response to the certificate chain request.

In response to the certificate chain request from the master device, the controlled device generates response information in the REE. The response information includes the certificate chain, and also includes a public key corresponding to the private key and a certification declaration (CD) file. The CD file is signed and issued by the cloud security alliance (CSA).

S803: Sending the response information to the master device, so that the master device uses the public key for signature verification after receiving the signed data.

The controlled device sends the response information to the master device, so that the master device can verify the certificate chain of the controlled device to ensure that it links back to a trusted root certificate authority (CA) for device attestation public key infrastructure (PKI). These root CAs are called product attestation authorities (PAAs) and are distributed using a distributed conformance ledger (DCL).

The master device performs verification according to the response information, such as verifying whether the CD file is signed by the CSA, and verifying whether the vendor ID (VID) and product ID (PID) in the DAC certificate and the CD certificate match.

After successfully verifying the certificate chain, the master device generates a nonce and sends an attestation request to the controlled device, and the attestation request includes the nonce for requesting attestation data of the controlled device. The attestation data can include the nonce sent by the master device.

The controlled device receives the attestation request sent by the master device based on the Matter protocol stack. In this case, the controlled device is in the REE execution environment.

S72: In response to the attestation request, switching from the REE to the TEE, and signing the attestation data with the private key in the TEE to obtain the signed data.

By performing the process of signing the attestation data with the private key in the TEE, the controlled device can prevent the private key from leaving the TEE and ensure the security and reliability of the signing process.

In some embodiments, the controlled device can switch from the REE to the TEE according to the process shown in FIG. 25, with specific steps as follows.

S251: In the REE, calling a TEE driver through a first interface to enter a monitor.

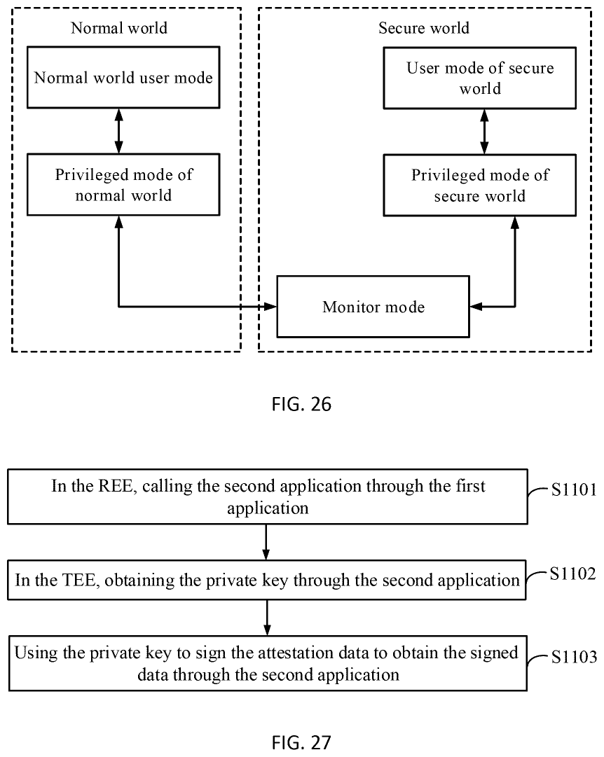

Combined with a mode diagram shown in FIG. 26, the REE is a normal world, and the TEE is a secure world. The TEE also includes a monitor, which is configured to switch the execution environment of the controlled device between the REE and the TEE.

When the controlled device needs to switch from the REE to the TEE, it can call the TEE driver through a first interface to enter the monitor. The first interface can be an open portable-TEE (OP-TEE) client API, which provides a set of functions allowing CA applications in the normal world to communicate with TA applications in the secure world and utilize the services provided by them. The TEE Driver can be an OP-TEE Linux Driver, which is a driver for communicating with OP-TEE in the Linux system, providing necessary underlying support, so that applications can enter the monitor through the TEE Driver by utilizing the security and protection mechanism of the OP-TEE.

S252: Switching the REE to the TEE through the monitor.

After entering the monitor, the REE is switched to the TEE through the monitor, i.e., switching from the normal world to the secure world. Related tasks, such as signing attestation data, are completed through the secure world to ensure the security of various data in the tasks and the security of the task execution process.

In some embodiments, during the switching process between the REE and the TEE, the controlled device can sign the attestation data through the first application and the second application according to the process shown in FIG. 27, with specific steps as follows.

S1101: In the REE, calling the second application through the first application.

The first application is an application running based on the REE, i.e., a CA application. The second application is a trusted application running based on the TEE, i.e., a TA application.

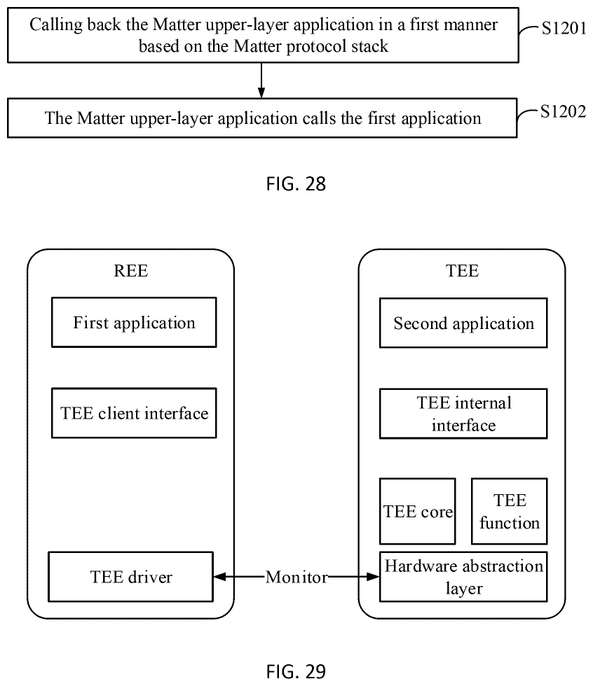

In some embodiments, the controlled device can call the first application according to the process shown in FIG. 28, with specific steps as follows.

S1201: Calling back the Matter upper-layer application in a first manner based on the Matter protocol stack.

The first manner includes a java native interface (JNI) manner. The Matter protocol stack uses the JNI manner to call back the Matter upper-layer application, which has cross-platform compatibility. Through the JNI, the Matter protocol stack can interact with the underlying native code, thereby achieving cross-platform compatibility. The Matter protocol stack can run on different operating systems and hardware platforms and communicate seamlessly with applications through the JNI. It can achieve performance optimization. The JNI manner allows the Matter protocol stack to directly call the underlying native code without additional language conversion or intermediate layers. This can improve execution efficiency and performance, especially for cases requiring processing large amounts of data or frequent calls. With native library support, through the JNI, the Matter protocol stack can directly use existing native libraries and functions, and these libraries may have been widely used and optimized in the underlying system. This can save development time and resources and obtain efficient and stable functions provided by the underlying libraries. It has the advantage of accessing system interfaces. The JNI allows the Matter protocol stack to directly access underlying system interfaces and functions, such as the file system, network, and sensors, etc. This enables the Matter protocol stack to more flexibly integrate and interact with specific functions of the device.

The first manner can also include other manners, such as callback function pointers, event mechanisms, message queues, interface calls, etc.

S1202: The Matter upper-layer application calls the first application.

The Matter upper-layer application first calls the first application in the REE to call the second application in the TEE through the first application.

Combined with the schematic diagram of the CA and the TA shown in FIG. 29, the first application (CA) calls the TEE driver, such as the OP-TEE Linux Driver, through the TEE client interface (OP-TEE Client API), and enters the monitor through the TEE driver. The hardware abstraction layer (HAL) in the TEE can be called through the monitor to switch the REE to the TEE, thereby realizing the call to the second application (TA).

S1102: In the TEE, obtaining the private key through the second application.

As shown in FIG. 29, the second application (TA) can access the TEE core and the functional implementation of the TEE, such as TEE functions, through the TEE internal interface (internal API) within the TEE. Thus, the second application can obtain the private key stored in the TEE through the TEE internal interface. In this way, the process of obtaining the private key by the second application is completely implemented in the TEE, which can effectively ensure the security of the process of obtaining the private key.

S1103: Using the private key to sign the attestation data to obtain the signed data through the second application.

The second application completes the signing process of the attestation data with the private key in the TEE, which can ensure that the private key never leaves the TEE, and the signing process will also be protected by the TEE, thereby ensuring the security of the private key and the security of the private key during use.

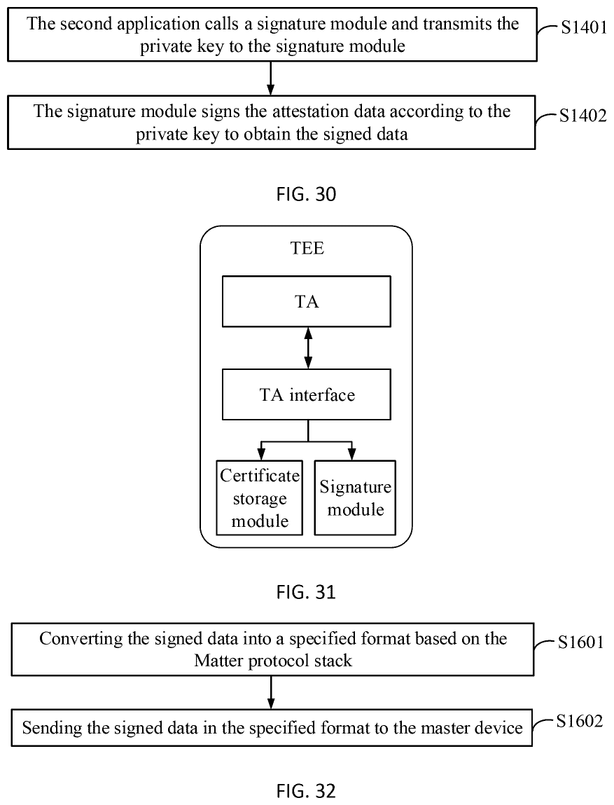

The controlled device can sign the attestation data with the private key by the second application according to the process shown in FIG. 30, with specific steps as follows.

S1401: The second application calls a signature module and transmits the private key to the signature module.

Referring to a schematic diagram of service modules in the TEE shown in FIG. 31, the TEE includes the second application (TA), a TA interface, a certificate storage module, and the signature module. It can be seen that the above modules all run based on the TEE and are internal modules of the TEE.

The second application calls the signature module through the TA interface and passes the obtained private key as a parameter to the signature module. Therefore, the acquisition of the parameter (private key) required by the signature module to execute the signature method is also performed in the TEE, which can ensure that the private key never leaves the TEE.

S1402: The signature module signs the attestation data according to the private key to obtain the signed data.

The signature module can be based on the elliptic curve cryptography (ECC) digital signature algorithm (elliptic curve digital signature algorithm, ECDSA). Before signing, the attestation data is first processed by Hash256 to obtain data to be signed. The second application passes the public key, the private key, the curve type, and the data to be signed into the signature module for signing to obtain the signed data.

S73: Switching from the TEE to the REE, and sending the signed data to the master device based on the Matter protocol stack in the REE, so that the master device performs signature verification according to the signed data and configures the network for the controlled device.

After obtaining the signed data, the controlled device switches the TEE to the REE through the monitor, and the second application returns the signed data to the first application to ensure that the data leaving the TEE does not carry the private key, thereby ensuring the security of the private key.

In the REE, the first application transmits the signed data back to the Matter upper-layer application through the OP-TEE Client API, and the Matter upper-layer application passes the signed data to the Matter protocol stack to send the signed data to the master device through the Matter protocol stack.

In some embodiments, the controlled device can send the signed data to the master device according to the process shown in FIG. 32, with specific steps as follows.

S1601: Converting the signed data into a specified format based on the Matter protocol stack.

The signed data in the specified format conforms to the communication protocol supported by the master device, such as the tag-length-value (TLV) format.

S1602: Sending the signed data in the specified format to the master device.

This can ensure that the master device can correctly parse and process the received signed data to perform device attestation on the controlled device.

The master device will verify whether the signed data includes the nonce sent by the master device, and verify whether it is signed by the private key of the controlled device, etc.

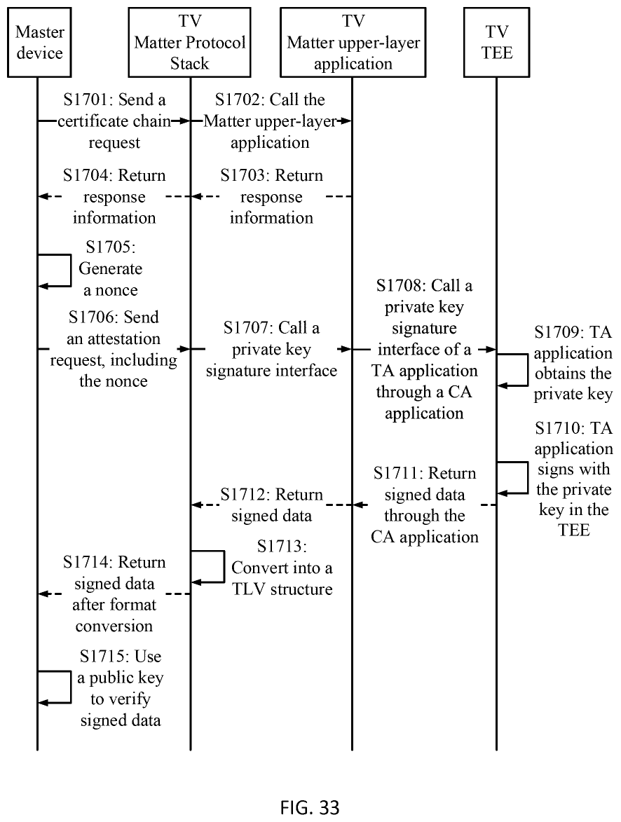

The device attestation process between the master device and the controlled device is exemplarily described with reference to FIG. 33. As shown in FIG. 33, taking the controlled device as a TV for an example, S1701: the master device sends a certificate chain request to the TV; S1702: the Matter protocol stack in the TV responds to the certificate chain request and calls the Matter upper-layer application; and the Matter upper-layer application generates response information in the REE, which includes a PAI certificate, a DAC certificate, and a public key; S1703: the Matter upper-layer application returns the response information to the Matter protocol stack in the TV; S1704: the Matter protocol stack in the TV returns the response information to the master device; S1705: the master device verifies the certificate chain according to the response information, and generates a nonce after the verification is passed; S1706: the master device sends an attestation request to the TV, and the attestation request includes the nonce; S1707: in response to the attestation request, the Matter protocol stack in the TV calls the private key signature interface; S1708: the Matter upper-layer application calls the CA application in the REE to call the private key signature interface of the TA application in the TEE through the CA application; S1709: the TA application obtains the private key stored by the TEE in the TEE; S1710: the TA application signs the attestation data with the private key in the TEE to obtain the signed data; S1711: the TA application returns the signed data to the Matter upper-layer application through the CA application; S1712: the Matter upper-layer application returns the signed data to the Matter protocol stack; S1713: the Matter protocol stack converts the signed data into a specified format, such as a TLV structure; S1714: the Matter protocol stack returns the signed data after format conversion to the master device; and S1715: the master device uses the public key to verify the signed data.

After the controlled device joins the virtual domain of the master device, the controlled device can be controlled by the master device. Based on the Multi-admin function of the Matter protocol, the controlled device can join the virtual domains of multiple master devices at the same time. In a virtual domain, all devices share the same CA and agree on a Fabric ID. After the controlled device joins the virtual domain of the master device, the controlled device is assigned an NOC certificate. Based on the above security features, a virtual domain can usually be an ecosystem, such as Google Fabric, Apple Fabric, Home Kit Fabric, Amazon Fabric, etc.

Therefore, a controlled device joining the virtual domains of multiple master devices is equivalent to being used by multiple ecosystems at the same time. If users cannot quickly and accurately know all master devices, they cannot reasonably and effectively control the master devices.

To solve the above problem, in the embodiments of the present application, the controlled device stores master device information, which is the device information of the master devices that have control permissions over the controlled device.

In some embodiments, the controlled device can manage the master device information through an ACL table. An example of the ACL table provided by the Matter is given as follows.

```
Access Control Cluster: {
  ACL: [
    0: {
        FabricIndex: 1,
        Privilege: Administer,
        AuthMode: CASE,
        Subjects: [ ],
        Targets: [ ]
        }
      ]
  }
```

Herein, the ACL array in the access control cluster has only one element. In this element, FabricIndex represents the Fabric ID of the virtual domain to which the controlled device belongs; Privilege represents permissions, such as administrator permissions (Administer); AuthMode represents the identity attestation mode, such as the CASE; Subjects: [ ] represents the Node ID of the node with control permissions in the virtual domain; Targets: [ ] represents that the node has control permissions over all contents. The element can also include other parameters, such as the manufacturer information, product name, device name, etc., which are not limited here.

In some embodiments, the controlled device is an electronic device and is configured with a function of displaying a list of master devices. Herein, the list of master devices includes master devices corresponding to the master device information, i.e., master devices that have control permissions over the controlled device.

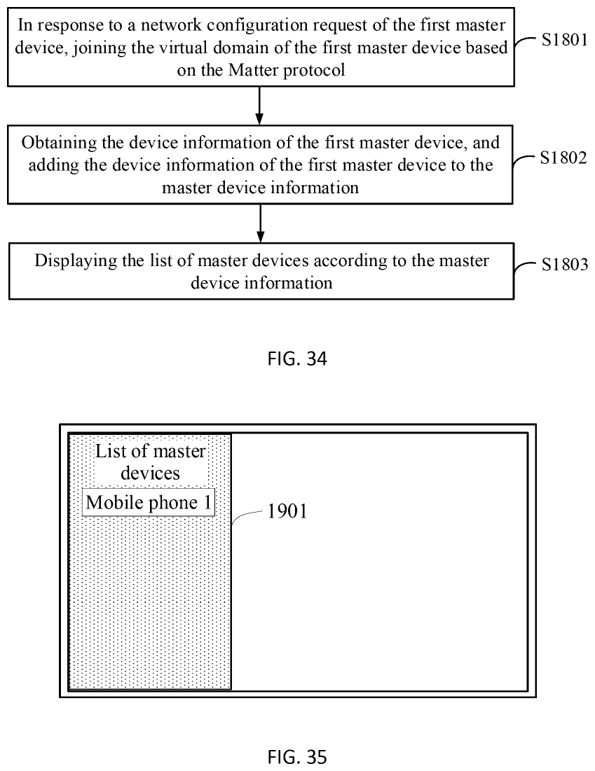

When the controlled device does not display the list of master devices, the controlled device can display the list of master devices according to the process shown in FIG. 34, with specific steps as follows.

S1801: In response to a network configuration request of the first master device, joining the virtual domain of the first master device based on the Matter protocol.

The first master device is the master device that currently configures the network for the controlled device. Step S1801 can refer to steps S401-S409 and S71-S73, which will not be repeated here.

S1802: Obtaining the device information of the first master device, and adding the device information of the first master device to the master device information.

After the controlled device joins the virtual domain of the first master device, the controlled device establishes a second secure session with the first master device and receives the NOC certificate and device information sent by the first master device based on the second secure session. The NOC certificate includes the Fabric ID of the virtual domain to which the first master device belongs. The device information of the first master device can include the manufacturer information, product name, device name, control permissions, etc. The manufacturer information can include the manufacturer name, the name of the control terminal App, etc., and the control terminal App is an App supporting Matter functions.

The controlled device adds the device information of the first master device to the master device information to manage the device information of the first master device.

S1803: Displaying the list of master devices according to the master device information.

The updated master device information includes the device information of the first master device, so that the list of master devices displayed according to the master device information includes the first master device.

In some embodiments, the virtual domain of the first master device may be the first virtual domain joined by the controlled device. In this case, the master device information only includes the device information of the first master device, so the list of master devices only includes the first master device. Taking the controlled device as a TV and the first master device as a mobile phone for an example, the device information of the mobile phone includes a device name, such as mobile phone 1. After the TV adds the device information of the mobile phone to the master device information, the TV displays the list of master devices 1901 as shown in FIG. 35 according to the master device information. If the list of master devices 1901 uses device names to represent the corresponding master devices, the list of master devices 1901 includes mobile phone 1.

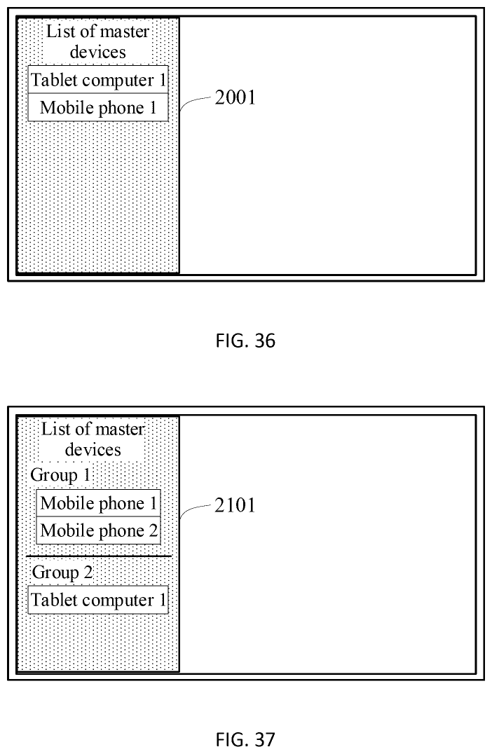

In other embodiments, before joining the virtual domain of the first master device, the controlled device has joined virtual domains of other master devices. In this case, the master device information includes both the device information of the first master device and device information of other master devices, so the list of master devices includes the first master device and other master devices. Taking the controlled device as a TV and the first master device as a mobile phone for an example, the device information of the mobile phone can include a device name, such as mobile phone 1. Before joining the virtual domain of the mobile phone, the TV has joined the virtual domain of a tablet computer, i.e., the master device information already includes device information of the tablet computer. The device information of the tablet computer can include a device name, such as tablet computer 1. After the TV adds the device information of the mobile phone to the master device information, the TV displays the list of master devices 2001 as shown in FIG. 36 according to the master device information. If the list of master devices 2001 uses device names to represent the corresponding master devices, the list of master devices 2001 includes tablet computer 1 and mobile phone 1. The tablet computer and the mobile phone can belong to different ecosystems, such as the tablet computer belonging to Apple and the mobile phone belonging to Amazon.

In some embodiments, after the controlled device adds the device information of the first master device to the master device information, the controlled device automatically displays the list of master devices according to the master device information. In this way, users can quickly know that the currently used master device has successfully configured the network for the controlled device through the list of master devices, and can also know all master devices corresponding to the controlled device based on the list of master devices.

In other embodiments, the controlled device displays the list of master devices according to the master device information in response to a first control command from the user. The first control command is used to instruct to display the list of master devices, so that the controlled device can display the list of master devices according to the actual needs of the user. The display entry of the list of master devices can be set in a corresponding application of the controlled device, in the setting menu of the controlled device, in a shortcut on a specified page, and/or on a control device of the controlled device, such as a remote control.

In some embodiments, if the master device information includes device information of multiple master devices, the list of master devices includes at least one group, and the device information of the corresponding master device is displayed in the group. The grouping is set according to preset conditions. The preset conditions can be that devices belonging to the same virtual domain are grouped together, devices in the same ecosystem are grouped together, devices of the same product category are grouped together, devices located in the same space (such as bedroom, living room, etc.) are grouped together, devices with the same control permissions are grouped together, devices with the same special mark (such as a common mark) added by the user are grouped together, etc. The device information of the master devices can include parameters related to the preset conditions, such as product category, location, control permissions, marks added by the user, etc. The controlled device can determine the group to which the master device belongs according to the device information of the master device. Taking the controlled device as a TV and the master devices corresponding to the master device information including mobile phone 1, mobile phone 2 and tablet computer 1 for an example, if grouping is performed according to product categories, the TV can display the list of master devices 2101 as shown in FIG. 37. The list of master devices 2101 includes group 1 and group 2, where group 1 includes mobile phone 1 and mobile phone 2, and group 2 includes tablet computer 1.

In some embodiments, the user can customize names of groups, such as customizing group 1 as a mobile phone group and group 2 as a tablet computer group, as shown in FIG. 37.

In some embodiments, the user can customize and configure preset conditions, which are not limited to the categories disclosed above.

In some embodiments, the user can customize the group to which the master device belongs. For example, the user can perform an editing operation on the controlled device to move a target master device from the current group to a target group. The editing operation can be that when the list of master devices is displayed, the use selects an option of the target master device and drags the option from the current group to the target group. After adjusting the group to which the target master device belongs, the controlled device correspondingly modifies the device information of the target master device in the master device information. This modification enables the device information of the target master device to include the target group based on the current preset condition, so that when the list of master devices is displayed again, the target master device is displayed in the target group.

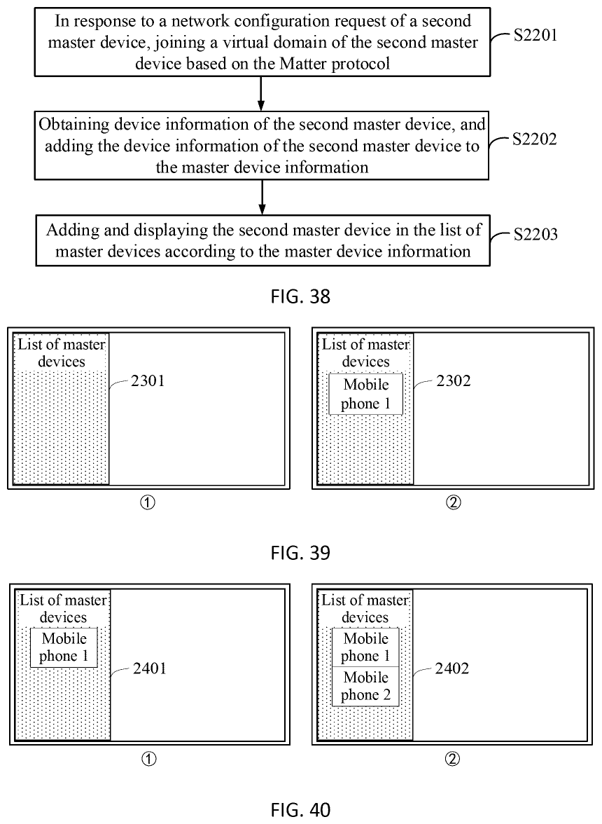

When the controlled device displays the list of master devices, the controlled device can update the list of master devices according to the process shown in FIG. 38, with specific steps as follows.

S2201: In response to a network configuration request of a second master device, joining a virtual domain of the second master device based on the Matter protocol.

S2202: Obtaining device information of the second master device, and adding the device information of the second master device to the master device information.

Steps S2201-S2202 can refer to steps S1801-S1802, which will not be repeated here.

S2203: Adding and displaying the second master device in the list of master devices according to the master device information.

The second master device can be added and displayed at the top or bottom of the list of master devices, or at the top or bottom of the corresponding group. In this way, the user can determine that the second master device has successfully configured the network for the controlled device based on the second master device added and displayed in the list of master devices.

In some embodiments, if the virtual domain of the second master device is the first virtual domain joined by the controlled device, the list of master devices displayed by the controlled device is empty before joining the virtual domain of the second master device. After the controlled device joins the virtual domain of the second master device, the updated list of master devices includes the second master device. Taking the controlled device as a TV and the second master device as mobile phone 1 for an example, as shown in \textcircled{1} in FIG. 39, when the TV displays the list of master devices 2301, the TV is configured with the network by mobile phone 1, and the list of master devices 2301 is empty. After the TV is successfully configured with the network by mobile phone 1, the TV updates and displays the list of master devices 2302 as shown in \textcircled{2} in FIG. 39, and the list of master devices 2302 includes mobile phone 1.

In some embodiments, if the controlled device has joined the virtual domains of other master devices before joining the virtual domain of the second master device, e.g., joining the virtual domain of the first master device according to steps S1801-S1803, the list of master devices displayed by the controlled device before joining the virtual domain of the second master device includes the first master device. After the controlled device joins the virtual domain of the second master device, the updated list of master devices includes both the first master device and the second master device. Taking the controlled device as a TV, the first master device as Mobile Phone 1, and the second master device as Mobile Phone 2 for an example: the TV has already joined the virtual domain of Mobile Phone 1, and as shown in \textcircled{1} in FIG. 40, the TV displays a list of master devices 2401, which includes Mobile Phone 1. While displaying the list of master devices 2401, the TV is configured with the network by Mobile Phone 2, and after successful network configuration by Mobile Phone 2, the TV updates and displays a list of master devices 2402 as shown in \textcircled{2} in FIG. 40, which includes Mobile Phone 1 and Mobile Phone 2.

In some embodiments, the Fabric capacity supported by the controlled device is limited, meaning the number of virtual domains the controlled device can join simultaneously is restricted, e.g., the maximum number of virtual domains it can join ranges from 5 to 254. The controlled device determines master devices that can be displayed in the list of master devices based on its supported Fabric capacity. For example, in a case that the number of virtual domains the controlled device has joined reaches the upper limit, if the controlled device is configured with the network again, the controlled device may display a pop-up window to inform the user that no more virtual domain can be joined and terminate the network configuration. Or, the controlled device may automatically exit the virtual domain of one master device to join the virtual domain of the master device that is currently configuring the network, ensuring the user's current needs are met.

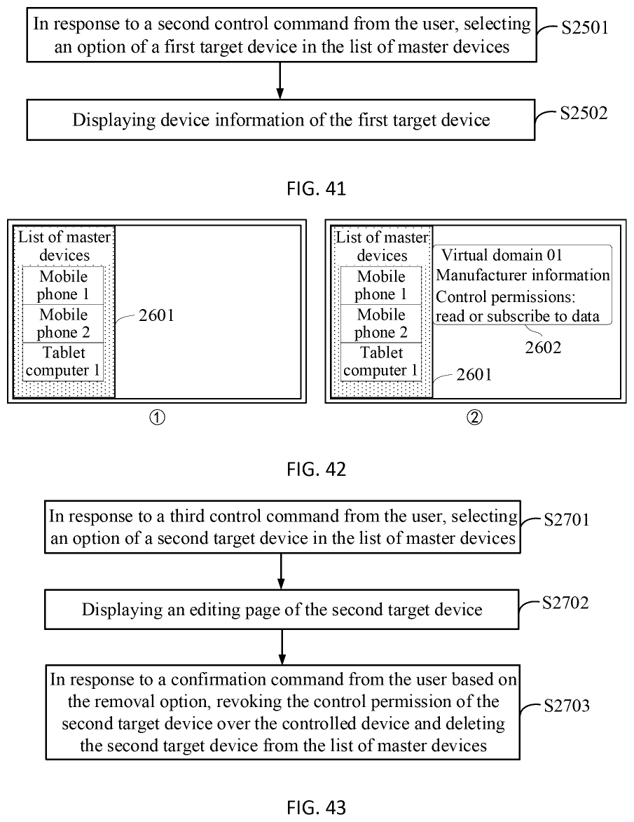

In some embodiments, when displaying the list of master devices, the controlled device shows partial content of device information of the master devices, e.g., electronic device names, in the list of master devices due to a size limitation of a display region of the list of master devices, allowing users to quickly identify key device information of the master devices. The controlled device can be configured to display more complete device information of the master devices based on user needs. The controlled device can display complete device information based on the process shown in FIG. 41, with specific steps as follows.

S2501: In response to a second control command from the user, selecting an option of a first target device in the list of master devices.

The second control command is used to instruct display of device information of the first target device. In some embodiments, the user can input the second control command by moving a focus to the option of the first target device. In some embodiments, the user can input the second control command by moving the focus to the option of the first target device and selecting the option.

The controlled device selects the option of the first target device in response to the second control command.

S2502: Displaying device information of the first target device.

The controlled device may display the device information of the first target device in a pop-up window. The pop-up window may be displayed corresponding to the option of the first target device to help the user accurately correspond the device information in the pop-up window to the corresponding master device.

Taking the controlled device as a TV for an example: as shown in \textcircled{1} in FIG. 42, the TV displays a list of master devices 2601, including Mobile Phone 1, Mobile Phone 2, and Tablet Computer 1. If the users want to view more complete information about Mobile Phone 1, they can move the focus to the option of Mobile Phone 1 using the remote control to input the second control command to the TV. In response to the second control command, the TV displays a pop-up window 2602 at a position corresponding to the option of Mobile Phone 1, as shown in \textcircled{2} in FIG. 42, and displays the device information of Mobile Phone 1 in the pop-up window 2602, such as manufacturer information: manufacturer name, name of the control terminal App, and control permissions (e.g., View, which refers to the permission to read or subscribe to data). The displayed device information may also include: device type, product name, location, etc. The pop-up window 2602 may also display the Fabric ID of the virtual domain to which Mobile Phone 1 belongs, e.g., Fabric 01.

In some embodiments, the controlled device is configured with an editing function for master devices.

The controlled device can remove a master device following the process in FIG. 43, with specific steps as follows.

S2701: In response to a third control command from the user, selecting an option of a second target device in the list of master devices.

The third control command is used to instruct display of an editing page of the second target device. In some embodiments, the user can input the third control command by moving a focus to the option of the second target device. In some embodiments, the user can input the third control command by moving a focus to the option of the second target device and selecting the option.

The controlled device selects the option of the second target device in response to the third control command.

S2702: Displaying an editing page of the second target device.

The editing page includes a removal option. In some embodiments, the editing page may be a pop-up window in step S2602, and the removal option is an option in the pop-up window. In some embodiments, the editing page may be a dedicated page, and the removal option is an option in the dedicated page.

S2703: In response to a confirmation command from the user based on the removal option, revoking the control permission of the second target device over the controlled device and deleting the second target device from the list of master devices.

The controlled device revokes the control permission of the second target device over the controlled device in response to the confirmation command. For example, the controlled device deletes device information of the second target device from the ACL table and sends a removal message to the second target device, so that the second target device determines it no longer has the control permission over the controlled device based on the removal message. The second target device may manage device information of controlled devices over which it has control permissions via the binding cluster of the Matter. In response to receiving the removal message sent by the controlled device, the second target device deletes the device information of the controlled device from the binding cluster.

The controlled device deletes the second target device from the list of master devices and deletes device information of the second target device from the master device information. In this way, the user can confirm that the second target device has been successfully removed based on the updated list of master devices, and the controlled device will no longer display the second target device when the list of master devices is displayed again.

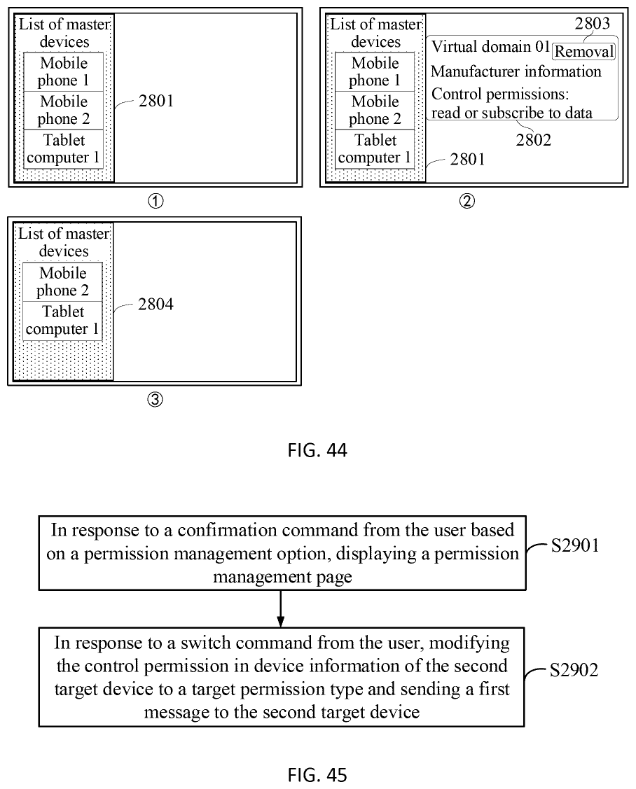

Taking the controlled device as a TV for an example: as shown in \textcircled{1} in FIG. 44, the TV displays a list of master devices 2801, including Mobile Phone 1, Mobile Phone 2, and Tablet computer 1. If the users want to remove control of Mobile Phone 1 over the TV, they can use the remote control to move a focus to an option of Mobile Phone 1, to input a third control command to the TV. In response to the third control command, as shown in \textcircled{2} of FIG. 44, the TV displays a pop-up window 2802 at a position corresponding to the option of Mobile Phone 1, with the pop-up window 2802 serving as an editing page. In the pop-up window 2802, device information of Mobile Phone 1, the Fabric ID of the virtual domain that Mobile Phone 1 belongs to, and a removal option 2803 are displayed. The user inputs a confirmation command based on the removal option 2803. In response to the confirmation command, the TV deletes Mobile Phone 1 from the list of master devices 2801 and displays a list of master devices 2804 as shown in \textcircled{3} of FIG. 44. The list of master devices 2804 includes Mobile Phone 2 and Tablet computer 1, excluding Mobile Phone 1. The TV revokes the control permission of Mobile Phone 1, such as deleting device information of Mobile Phone 1 from the ACL table, and sends a removal message to Mobile Phone 1, ensuring that Mobile Phone 1 will no longer be displayed when the list of master devices is displayed again.

In some embodiments, the editing page may further include a permission management option. The controlled device can modify the control permissions of master devices based on the process in FIG. 45, with specific steps as follows.

S2901: In response to a confirmation command from the user based on a permission management option, displaying a permission management page.

The permission management page is used to set permission types of the second target device for the controlled device. The permission types may include View, Operate, Manage, and Administer. Herein, the Operate permission includes writing operational data and invoking operational commands; the Manage permission includes writing configuration data and invoking configuration commands; and the Administer permission includes writing management data and invoking management commands.

The permission management page may include a switch for each permission type. Enabling a switch for a permission type activates the permission type, while disabling a switch for a permission type revokes the permission type. The permission management page may include a selection option for the permission type, allowing users to select the permission type to be enabled.

S2902: In response to a switch command from the user, modifying the control permission in device information of the second target device to a target permission type and sending a first message to the second target device.

The switch command is used to instruct the modification of the current control permission of the second target device to the target permission type, and the modification of the control permission in the device information of the second target device to the target permission type, so that when the list of master devices is displayed, the control permission of the second target device is displayed as the target permission type.

The controlled device also sends a first message to the second target device. The first message includes modifying the control permission to the target permission type. In response to the first message, the second target device modifies the control permission to the target permission type, to determine that the control permission over the controlled device is the target permission type.

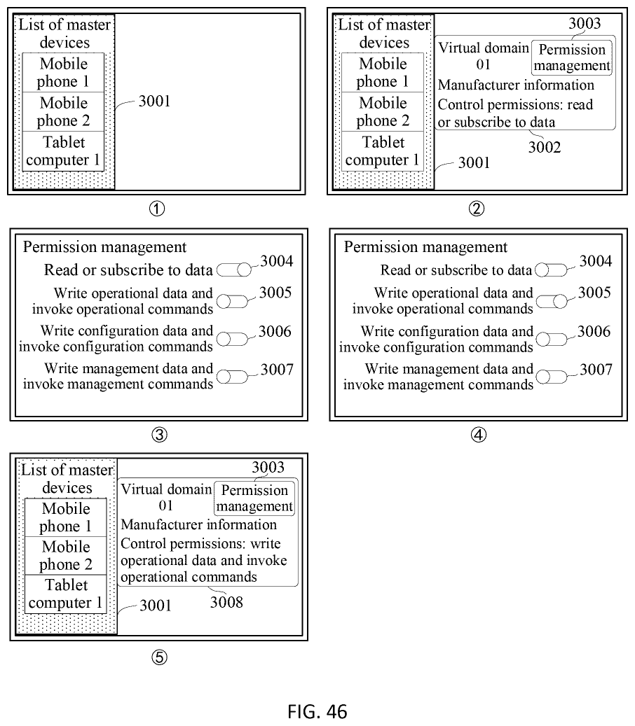

Taking the controlled device as a TV for an example: as shown in \textcircled{1} in FIG. 46, the TV displays a list of master devices 3001, including Mobile Phone 1, Mobile Phone 2, and Tablet Computer 1. If the users want to modify the control permission of Mobile Phone 1 for the TV, they can control a focus to move to an option of Mobile Phone 1 via the remote control to input a third control command to the TV. In response to the third control command, as shown in \textcircled{2} of FIG. 46, the TV displays a pop-up window 3002 at a position corresponding to the option of Mobile Phone 1, and the pop-up window 3002 serves as an editing page. The pop-up window 3002 displays the device information of Mobile Phone 1, the Fabric ID of the virtual domain to which Mobile Phone 1 belongs, and a permission management option 3003. The user inputs a confirmation command based on the permission management option 3003. In response to the confirmation command, the TV displays a permission management page as shown in \textcircled{3} of FIG. 46. The permission management page includes a switch for each permission type, such as the View switch 3004, the Operate switch 3005, the Manage switch 3006, and the Administer switch 3007. If the current permission type of Mobile Phone 1 is View, the View switch 3004 is in the on state. The user can input a switch command based on the Operate switch 3005 to switch the control permission of Mobile Phone 1 to Operate, as shown in \textcircled{4} of FIG. 46. The TV modifies the control permission in the device information of Mobile Phone 1 to Operate. If the TV displays the device information of Mobile Phone 1 again, the TV can display a pop-up window 3008 as shown in \textcircled{5} of FIG. 46, where the control permission of Mobile Phone 1 is Operate. The TV also sends a first message to Mobile Phone 1, and the first message includes modifying the control permission to Operate.

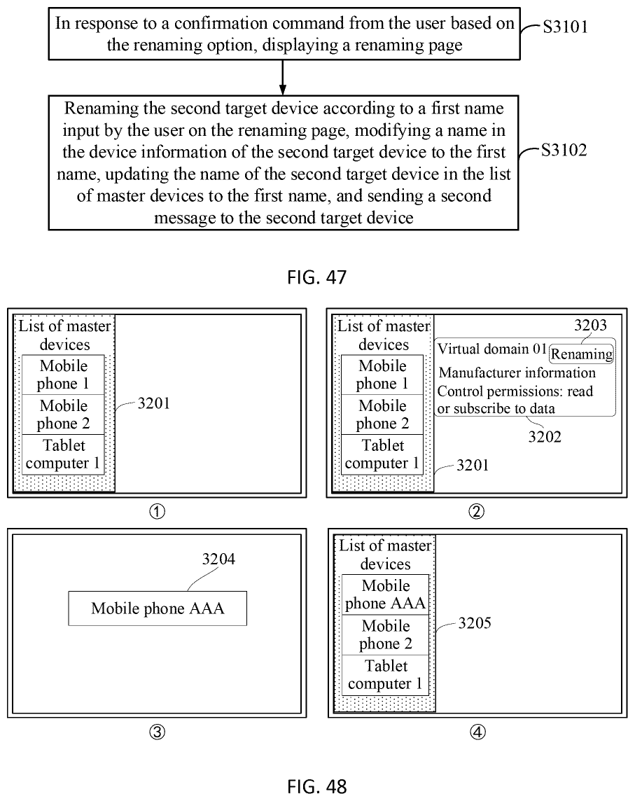

In some embodiments, the editing page may also include a renaming option. The controlled device can rename a master device following the process in FIG. 47, with specific steps as follows.

S3101: In response to a confirmation command from the user based on the renaming option, displaying a renaming page.

The renaming page includes a text input box for the user to input a new name of the second target device.

S3102: Renaming the second target device according to a first name input by the user on the renaming page, modifying a name in the device information of the second target device to the first name, updating the name of the second target device in the list of master devices to the first name, and sending a second message to the second target device.

The first name is the new name set by the user for the second target device. The controlled device modifies the name in the device information of the second target device to the first name, so that when the list of master devices is displayed, the first name of the second target device is displayed.

The controlled device also sends a second message to the second target device. The second message includes modifying the name to the first name. In response to the second message, the second target device modifies the name to the first name and makes the first name publicly available.

Taking the controlled device as a TV for example, as shown in \textcircled{1} of FIG. 48, the TV displays a list of master devices 3201, which includes Mobile Phone 1, Mobile Phone 2, and Tablet Computer 1. If the users want to rename Mobile Phone 1, they can control a focus to move to the option of Mobile Phone 1 via the remote control to input a third control command to the TV. In response to the third control command, as shown in \textcircled{2} of FIG. 48, the TV displays a pop-up window 3202 at the position corresponding to the option of Mobile Phone 1, and the pop-up window 3202 serves as an editing page. The pop-up window 3202 displays the device information of Mobile Phone 1, the Fabric ID of the virtual domain to which Mobile Phone 1 belongs, and a renaming option 3203. The user inputs a confirmation command based on the renaming option 3203. In response to the confirmation command, the TV displays a renaming page as shown in \textcircled{3} of FIG. 48. The renaming page includes a text input box 3204. The user can input the first name, such as Mobile Phone AAA, based on the text input box 3204. The TV modifies the name in the device information of Mobile Phone 1 to Mobile Phone AAA according to the first name. If the TV displays the list of master devices again, the TV can display the list of master devices 3205 as shown in \textcircled{4} of FIG. 48, which includes Mobile Phone AAA, Mobile Phone 2, and Tablet Computer 1. The TV also sends a second message to Mobile Phone 1, and the second message includes modifying the name to Mobile Phone AAA.

In addition to the above embodiments, the present application also provides other embodiments related to an electronic device, a terminal device, and device network configuration, described as follows.

The terminal device provided in the embodiments may take various forms, such as a TV, a laser projection device, a monitor, an electronic bulletin board, an electronic table, etc.

In some embodiments, the electronic device 200 may integrate a Matter application in an application layer. The Matter application can assist the electronic device 200 in establishing an interactive connection with Matter devices, enabling the electronic device 200 to perform home control on Matter devices in accordance with the Matter protocol. The Matter protocol is an open-source smart home connection protocol that supports interconnection between smart home devices and a control platform, allowing an operating status of smart home devices to be controlled through the control platform. In the embodiment, the electronic device 200 can be installed indoors to act as a control terminal and execute control on Matter devices in the same region according to control commands from the user.

A Matter device is a smart home hardware product with Matter protocol functions, and can be controlled by the electronic device 200 which is used as its control terminal. A Matter device can be a home device in the same region as the electronic device 200, such as a light bulb, switch, sensor, thermostat, blind motor, door lock, bridge device, and media playback device, etc. A Matter device can be provided with a sensor, a sensing switch, etc., to control the startup and operation of the Matter device.

In some embodiments, the electronic device 200 can be wirelessly connected to Matter devices, thereby controlling the Matter devices through remote communication. For example, when a user sends a voice command to the electronic device 200: “Please turn on the bedroom light”, the at least one processor 250 of the electronic device 200 can convert the voice command into a control command and send the control command to the bedroom light bulb through the wireless connection channel to turn on the bedroom light.

In the above embodiment, the electronic device 200 needs to send the control command to the sensor of the Matter device via a wireless network, and the sensor may start or shut down the Matter device according to the control command. Thus, before the electronic device 200 controls the operation of the Matter device, it is necessary to perform Matter network configuration on the Matter device.

In some embodiments, the electronic device 200 can configure the network for Matter devices through wireless communication, for example, by activating a Bluetooth module of the electronic device 200 and searching for devices to be network-configured to complete pairing connection and network configuration. The electronic device 200 may also be provided with an image capture interface, and is connected to a camera through the image capture interface. Through the camera, the electronic device 200 can scan the identification code on the Matter device. The identification code contains network signals required to establish a network connection with the Matter device, thereby completing the pairing connection between the electronic device 200 and the Matter device, enabling the control terminal to configure the network for the Matter device.

However, due to differences in home structure designs, there may be a certain distance between the electronic device 200 and the Matter device to be network-configured. When the electronic device 200 is far away from the Matter device, the electronic device 200 cannot connect to Bluetooth of the Matter device. Moreover, because the electronic device 200 occupies a relatively large space, it is also inconvenient to scan the QR code on the Matter device. This results in inconvenient network configuration interaction between the electronic device 200 as a control terminal and the Matter device.

To address the difficulty in the network configuration interaction between the control terminal and Matter devices, some embodiments of the present application provide an electronic device 200. The electronic device 200 includes a first communication interface and a second communication interface. The first communication interface is configured to establish a first communication connection with a terminal device 300, and the second communication interface is configured to establish a second communication connection with a device to be network-configured.

The first communication connection can be established via a WiFi connection or within the same hotspot network. The terminal device 300 may be a movable device, such as a smartphone, a smartwatche, etc. This enables the terminal device 300 to scan the identification code of the device to be network-configured after the electronic device 200 is connected to the terminal device 300.

In some embodiments, both the electronic device 200 and the terminal device 300 can have an application installed for Matter connection. The electronic device 200 and the terminal device 300 can launch the application simultaneously to establish a first communication channel through identity information pairing. In this embodiment, to ensure a stable network environment for the first communication channel, the electronic device 200 and the terminal device 300 can be in the same network environment.

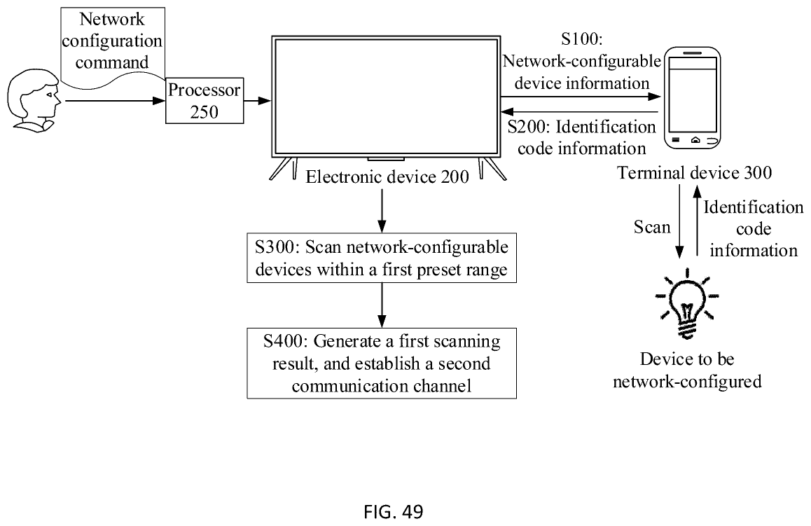

As shown in FIG. 49, the electronic device 200 may further include at least one processor 250 configured to execute the following method.

S100: In response to a network configuration command from the user, sending device information of a device to be network-configured to the terminal device.

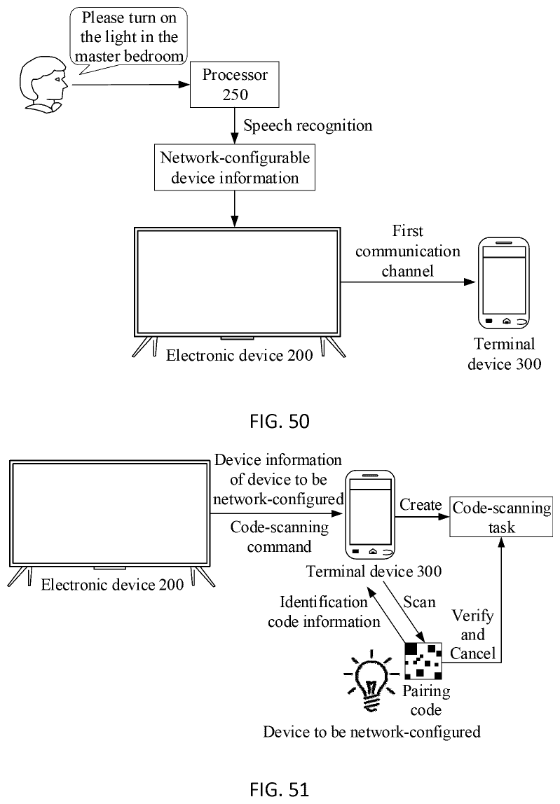

In some embodiments, the user can input a network configuration command to the electronic device 200 through various input methods such as the voice, gesture, touchpad, or remote control. The network configuration command may include device information of the device to be network-configured; and the device information includes the device name, device model, device installation location, device readiness status, etc. As shown in FIG. 50, when the user inputs a network configuration command such as “Please turn on the light in the master bedroom” via voice to the electronic device 200, the at least one processor 250 performs speech recognition on the network configuration command to obtain that the device to be network-configured is a “light” and located in the “master bedroom”, and sends the above device information of the device to be network-configured to the terminal device 300 through the first communication channel.

There may be one or more devices with Matter protocol functions around the electronic device 200. The device to be network-configured refers to the Matter device specified in the network configuration command.

In some embodiments, before receiving the network configuration command, the at least one processor 250 may establish a communication connection with a power system in the region where the electronic device 200 is located, and the region may be a home interior, office region, home exhibition region, etc. Based on the device information of the device to be network-configured, the at least one processor 250 can determine the readiness status of the device to be network-configured through the power system, e.g., the power level of the device to be network-configured, whether there is a fault in the device to be network-configured and the like; and send the device information to the terminal device 300 according to the readiness status.

S200: Obtaining identification code information through the first communication channel.

The identification code information is generated by the terminal device 300 scanning the pairing code corresponding to the device information. After the terminal device 300 obtains the device information of the device to be network-configured sent by the electronic device 200, the user can activate the camera of the terminal device 300 and call up a scanning frame to scan the pairing code of the device to be network-configured via the terminal device 300.

The terminal device 300 can display the device information of the device to be network-configured on a display of the terminal device 300 through an application for Matter connection, prompting the user to hold the terminal device 300 close to the device to be network-configured and scan the pairing code of the device to be network-configured through the terminal device 300. The terminal device 300 may parse the pairing code to obtain identification code information. The identification code information serves as identification information for the device to be network-configured. Each Matter device has the unique identification code information, which is used to identify the corresponding Matter device.

The terminal device 300 may return the identification code information to the electronic device 200 through the first communication channel, enabling the at least one processor 250 to search for the device to be network-configured based on the identification code information.

In some embodiments, as shown in FIG. 51, when sending the device information of the device to be network-configured to the terminal device 300, the at least one processor 250 may also send a code-scanning command to the terminal device 300 through the first communication channel. In response to receiving the device information of the device to be network-configured and the code-scanning command, the terminal device 300 creates a code-scanning task based on the device information, prompting the user to scan the pairing code corresponding to the device information via the terminal device 300. After creating the code-scanning task, the at least one processor 250 may send prompt information to the terminal device 300 every first duration, to remind the user to complete the scanning task via the terminal device 300 promptly. The scanning task is verified and canceled after the terminal device 300 completes scanning.

In some embodiments, to prevent devices that are not for network configuration from configuring the network for the device to be network-configured, the pairing code may also be set with a decoding key. After scanning the pairing code, the terminal device 300 may obtain scanning information and use the pre-stored decoding key to decode the scanning information, thereby obtaining the identification code information and enhancing the security of the device to be network-configured.

In some embodiments, the terminal device 300 may convert the pairing code into a digital signal using an optical recognition technology and extract the identification code information from the digital signal. In the process, the terminal device 300 can obtain the pairing code through an image acquisition interface; identify a type of the pairing code, e.g., the pairing code is a QR code or barcode; and use an image processing recognition algorithm to recognize a shape of the pairing code and black-and-white blocks in the pairing code, to convert them into the digital signal based on positions of the black-and-white blocks to extract the identification code information.

S300: Performing wireless communication scanning on network-configurable devices within a first preset range based on the identification code information.

After receiving the identification code information, the at least one processor 250 of the electronic device 200 needs to search for the device to be network-configured based on the identification code information to establish a second communication channel with the device to be network-configured via the second communication interface, thereby completing network configuration for the device to be network-configured. In the embodiment, the at least one processor 250 may scan network-configurable devices through wireless communication.

In some embodiments, wireless communication may include technologies such as Bluetooth, infrared scanning, radio, or electromagnetic waves. However, different wireless communication technologies have different scanning coverage ranges. Thus, the at least one processor 250 may perform wireless communication scanning on network-configurable devices within the first preset range, and the first preset range refers to a coverage range of a communication method with the largest wireless communication coverage range.

Since different wireless communication technologies have varying scanning coverage ranges, for network-configurable devices at a distance less than a first distance from the electronic device 200, technologies such as infrared scanning and electromagnetic waves can be used for scanning. For network-configurable devices at a distance greater than the first distance from the electronic device 200, wireless communication technologies such as Bluetooth modules and radio can be used for scanning; and through scanning, pairing is performed sequentially on the network-configurable devices surrounding the electronic device 200 to determine the device to be network-configured.

It should be noted that the network-configurable devices are all Matter devices. Each Matter device is provided with a communication device for being scanned by the electronic device 200. When the Matter device is in an operating state or a standby state, the communication device can continuously send communication signals to the outside, facilitating the electronic device 200 to perform scanning and pairing on it.

In some embodiments, the at least one processor 250 may detect the wireless communication operating status of the electronic device 200 based on the identification code information sent by the terminal device 300. If the wireless communication operating status is in an unactivated state, the at least one processor 250 may switch the wireless communication operating status to an activated state.

When detecting that the wireless communication operating status is in the activated state, the at least one processor starts to perform wireless communication scanning on the network-configurable devices within the first preset range and obtains network-configurable device information of the scanned devices. To filter out the device to be network-configured from the network-configurable devices, the at least one processor 250 may perform pairing for the network-configurable device information based on the identification code information.

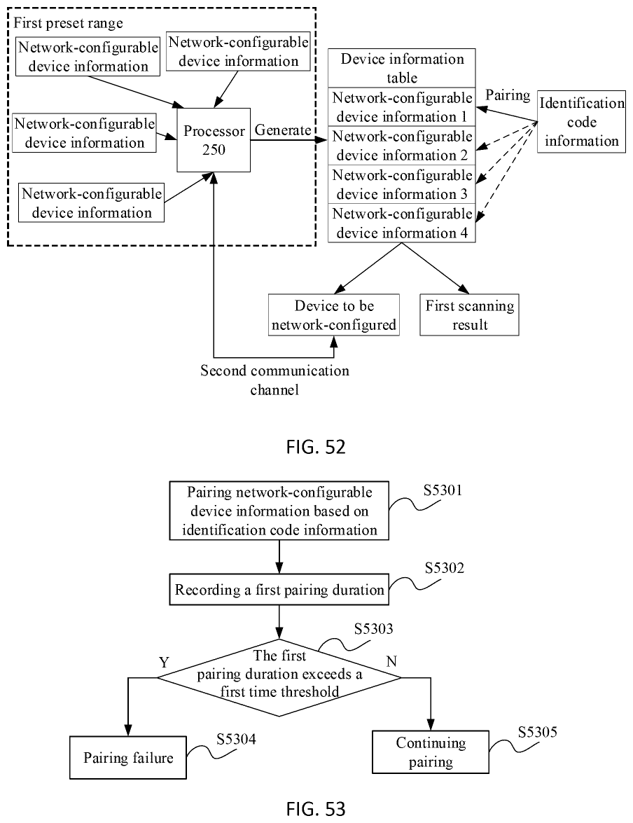

To facilitate pairing, as shown in FIG. 52, the at least one processor 250 can generate a device information table based on the network-configurable device information obtained through scanning. When a first piece of network-configurable device information appears in the device information table, the at least one processor 250 can start performing pairing using the identification code information. During the pairing process, the at least one processor 250 continues to perform wireless communication scanning on the network-configurable devices around the electronic device 200 and adds their network-configurable device information to the device information table one by one, thereby saving the time spent on pairing and improving network configuration efficiency.

The network-configurable device information can include the identification code information of the network-configurable devices. The at least one processor 250 can compare the identification code information of the device to be network-configured with identification code information of other network-configurable devices. If the identification code information of other network-configurable devices is the same as the identification code information of the device to be network-configured, it indicates that the pairing is successful.

In some embodiments, when the electronic device 200 performs wireless communication scanning on the network-configurable devices, the at least one processor 250 may record a first pairing duration of the electronic device 200. The at least one processor 250 may then perform pairing for the network-configurable device information based on the identification code information within the first pairing duration.

To determine whether the pairing of the electronic device 200 has failed, in the embodiments, as shown in FIG. 53, a first time threshold can be set to assist in determining a pairing result. Specifically, it includes the following steps.

S5301: Pairing network-configurable device information based on the identification code information.

S5302: Recording a first pairing duration.

S5303: Determining whether the first pairing duration exceeds the first time threshold. If yes, executing S5304; otherwise, executing S5305.

S5304: Determining pairing failure.

That is, when the first pairing duration exceeds the first time threshold, it indicates that at least one processor 250 has not paired with network-configurable devices with the same identification code information within the first time threshold.

S5305: Continuing pairing.

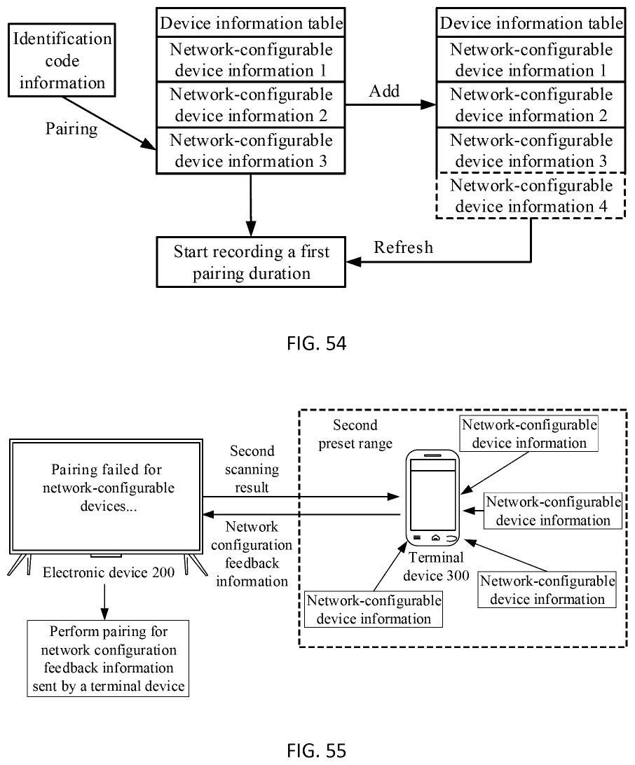

In some embodiments, since at least one processor 250 continues scanning the network-configurable devices and adding network-configurable device information during the pairing process, the first pairing duration includes the waiting time for at least one processor 250 performing scanning. Thus, as shown in FIG. 54, at least one processor 250 may also start recording the first pairing duration when pairing the latest added network-configurable device information, and restart timing the first pairing duration when network-configurable device information is newly added.

S400: In response to generating a first scanning result, establishing a second communication channel with the device to be network-configured and configuring the network for the device to be network-configured via the second communication channel.

When the at least one processor 250 generates the first scanning result, it indicates that network-configurable device information of the device to be network-configured has been obtained by scanning within a scanning range of the electronic device 200. Therefore, the at least one processor 250 can directly establish the second communication channel with the device to be network-configured. Herein, a wireless communication method of the second communication channel may be different from that of the first communication channel. For example, the first communication channel is a wireless network connection, and the second communication channel is a Bluetooth communication connection. After the at least one processor 250 establishes the second communication channel with the device to be network-configured, the at least one processor 250 may configure the network for the device to be network-configured through the second communication channel.

In some embodiments, the electronic device 200 can also obtain the identification code information by inputting the identification code. The user can control the electronic device 200 to display an identification code input box through the control device 100, and input the identification code information via the keyboard on the control device 100, so that the electronic device 200 can obtain the identification code information.

When the at least one processor 250 does not generate the first scanning result, it indicates that the electronic device 200 has failed to pair with the device to be network-configured. In this case, the at least one processor 250 generates a second scanning result.

The second scanning result indicates that the electronic device 200 has not detected any other network-configurable devices that can pair with the device to be network-configured. This indicates that other network-configurable devices around the electronic device 200 are not the the device to be network-configured. In some embodiments, to expand the scanning range for searching for the device to be network-configured, after generating the second scanning result, the at least one processor 250 may send the second scanning result to the terminal device 300. After receiving the second scanning result, the terminal device 300 may activate its wireless communication operation module based on the second scanning result, for example, activating the Bluetooth module of the terminal device 300.

After the terminal device 300 activates the Bluetooth module, the terminal device 300 also has the capability to scan for the network-configurable devices. In this case, the terminal device 300 can scan for other network-configurable devices in a second preset region via Bluetooth communication and obtain device information of these network-configurable devices. Herein, the second preset region refers to the maximum wireless communication scanning coverage range of the terminal device 300.

In some embodiments, the at least one processor 250 may also generate a terminal scanning command based on the second scanning result. The terminal scanning command is used to instruct the terminal device 300 to activate the wireless communication operation module. The at least one processor 250 may send the terminal scanning command to the terminal device 300. In response to the terminal scanning command, the terminal device 300 can activate the wireless communication operation module and start performing wireless communication scanning within the coverage region where the terminal device 300 is located.

Since the terminal device 300 is separated from the electronic device 200 by a certain distance, the terminal device 300 can scan in a region that is beyond the scanning range of the electronic device 200, thereby expanding the range for scanning the device to be network-configured. Therefore, as shown in FIG. 55, the terminal device 300 can obtain network-configurable device information outside the scanning range of the electronic device 200, and return the network-configurable device information as network configuration feedback information corresponding to the terminal scanning command to the electronic device 200.

After receiving the device information sent by the terminal device 300, the at least one processor 250 may continue to add the device information sent by the terminal device 300 to the original device information table and proceed to perform pairing for these pieces of device information.

In some embodiments, the first preset range and the second preset range may have an overlapping scanning region. When there are network-configurable devices located in the overlapping scanning region, for ease of description, the network-configurable device located in the overlapping scanning region is defined as an overlapping device in the embodiments. Both the electronic device 200 and the terminal device 300 can scan and obtain the network-configurable device information of the overlapping device, resulting in multiple acquisitions of the network-configurable device information of the overlapping device and reducing the network configuration efficiency.

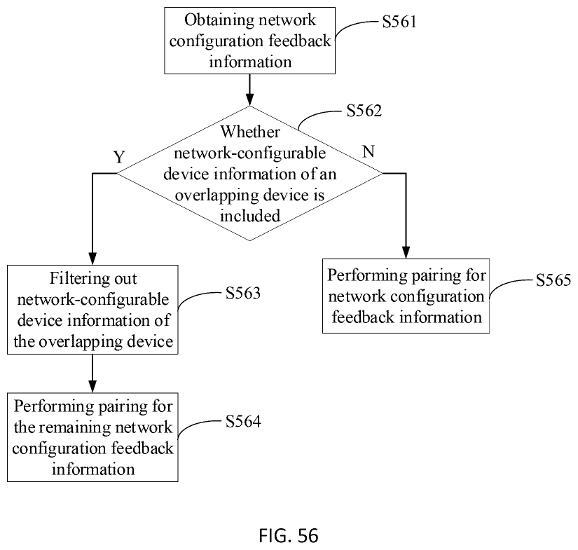

Therefore, as shown in FIG. 56, the at least one processor 250 performs the following steps.

S561: Obtaining network configuration feedback information.

S562: Determining whether the network configuration feedback information includes network-configurable device information of an overlapping device; if yes, executing step S563; otherwise, executing step S565.

S563: Filtering out the network-configurable device information of the overlapping device.

S564: Performing pairing for the remaining network configuration feedback information.

S565: Performing pairing for the network configuration feedback information.

That is to say, after receiving the network configuration feedback information, the at least one processor 250 may filter the network configuration feedback information according to network-configurable device information in the device information table. Herein, the network configuration feedback information may include one or more pieces of network-configurable device information. The at least one processor 250 may obtain the network-configurable device information in the current device information table and traverse the network configuration feedback information according to the network-configurable device information in the current device information table. If the network configuration feedback information includes the network-configurable device information that already exists in the device information table, it indicates that a network-configurable device corresponding to the network-configurable device information is an overlapping device. In this case, the at least one processor 250 retains the network-configurable device information in the device information table and deletes the network-configurable device information of the overlapping device from the network configuration feedback information.

After completing the filtering process, the at least one processor 250 adds network-configurable device information that is not the network-configurable device information of the overlapping device in the network configuration feedback information to the device information table. Simultaneously, the at least one processor 250 performs pairing for the network-configurable device information in the network configuration feedback information based on the identification code information. When there is network-configurable device information in the network configuration feedback information that successfully pairs, the at least one processor 250 can mark the network-configurable device corresponding to the successfully paired network-configurable device information as a device to be network-configured.

In some embodiments, the terminal device 300 may also perform pairing for the network configuration feedback information. Since the terminal device 300 has already scanned the pairing code of the device to be network-configured, the terminal device 300 also contains identification code information. Therefore, the terminal device 300 can also perform the step of filtering out the network-configurable device information of the overlapping device from the network configuration feedback information and perform pairing for the network-configurable device information in the network configuration feedback information based on the identification code information.

After the terminal device 300 successfully performs pairing for the network-configurable device information based on the identification code information, the at least one processor 250 can send a network configuration command to the terminal device 300, so that the terminal device 300 can establish a wireless communication connection with the device to be network-configured. The wireless communication connection may include a Bluetooth communication connection. Since the terminal device 300 has activated the Bluetooth communication module when scanning the network-configurable device information, the terminal device 300 can directly send a Bluetooth connection request to the device to be network-configured and wait for the device to be network-configured to respond to the Bluetooth connection request.

After receiving the Bluetooth connection request, the device to be network-configured may automatically determine its connection status. If the device to be network-configured is currently establishing a Bluetooth communication connection with another device, the device to be network-configured cannot establish a Bluetooth communication connection with the terminal device 300. In this case, the device to be network-configured may feed back busy status information to the terminal device 300, and the busy status information indicates that the device to be network-configured is being connected with another device and the Bluetooth communication connection is in a busy status. The busy status information may further include device information of the device that is currently connected to the device to be network-configured, and a duration for which the connection has been established, etc., so that the user can obtain the current status of the device to be network-configured.

In some embodiments, since the terminal device 300 is smaller in size compared to the electronic device 200, users can hold and move the terminal device 300. Therefore, after generating the second scanning result, the at least one processor 250 can send movement information to the terminal device 300 through the first communication channel. The movement information can be displayed on a display of the terminal device 300 to prompt the user to move the terminal device 300 toward a direction of the device to be network-configured, so as to facilitate the pairing between the terminal device 300 and the device to be network-configured.

In some embodiments, the at least one processor 250 can also obtain location information of the terminal device 300 and a distance between the terminal device 300 and the device to be network-configured through the first communication channel. In the above process, the terminal device 300 can send a global positioning System (GPS) positioning request to the server 400 to obtain positioning information of the terminal device 300 fed back by the server 400, and send the positioning information to the at least one processor 250. The at least one processor 250 can generate corresponding movement information according to the positioning information of the terminal device 300 and the location of the device to be network-configured, so as to guide the user to move the terminal device 300 according to the corresponding movement information.

In some embodiments, in a process that the user moves the terminal device 300, the scanning range of the terminal device 300 may change along with the movement of the terminal device 300. Therefore, the at least one processor 250 can generate a movement trajectory of the terminal device 300 according to the positioning information of the terminal device 300 fed back by the server 400, and delimit a second preset range according to the movement trajectory. The second preset range refers to the maximum range scanned when the scanning coverage of the terminal device 300 moves along the movement trajectory. The at least one processor 250 can then control the terminal device 300 to obtain the network-configurable device information within the second preset range according to the identification code information.

In some embodiments, the at least one processor 250 may also time the pairing duration of the terminal device 300 and record a second pairing duration of the terminal device 300 via the first communication channel. Since a device model of the terminal device 300 differs from that of the electronic device 200, the at least one processor may set a second time threshold to determine the pairing status of the terminal device 300. If the second pairing duration exceeds the second time threshold, it indicates that the terminal device 300 failed to pair with network-configurable devices within the second preset range. In this case, the terminal device 300 may generate prompt information, and the prompt information is used to indicate that the terminal device 300 has failed to pair within the second time threshold. The prompt information can be presented as text or voice, for example: “Pairing failed, please try again later!” After generating the prompt information, the terminal device 300 sends the prompt information to the electronic device 200. After receiving the prompt information, the electronic device 200 may restart the pairing process based on the prompt information.

In some embodiments, the present application provides a terminal device 300, which includes a display, a communication device, and at least one processor. Herein, the communication device is configured to establish a first communication channel with the electronic device 200, and the at least one processor is configured to: in response to a network configuration command from the user, receive device information of the device to be network-configured sent by the electronic device 200 via the first communication channel, where the terminal device 300 and the electronic device 200 are in the same network environment; and send identification code information to the electronic device 200 via the first communication channel, to enable the electronic device 200 to perform wireless communication scanning on network-configurable devices within a first preset range based on the identification code information. The identification code information is generated by scanning the pairing code corresponding to the device information. When the electronic device 200 generates a first scanning result, the electronic device 200 establishes a second communication channel with the device to be network-configured and configures the network for the device to be network-configured via the second communication channel.

It is understood that in some embodiments, after the terminal device 300 receives the device information of the device to be network-configured sent by the electronic device 200, the user can use keyboard keys or touch functions provided on the terminal device 300. The at least one processor can monitor the user's key event or touch event and generate a corresponding network configuration command based on the key event or touch event. In response to the network configuration command, the at least one processor can control the display of the terminal device 300 to display a scanning frame. In this case, the user can manually adjust the position and angle of the terminal device 300 to align the scanning frame with the pairing code, thereby improving the accuracy of the terminal device 300 recognizing the pairing code.

In some embodiments, the terminal device 300 may also receive the network configuration command from the electronic device 200, and the at least one processor may execute the above method steps in response to the network configuration command.

In some embodiments, the terminal device 300 may send a GPS positioning request to the server 400 to obtain the positioning information of the terminal device 300 fed back by the server 400, and then send the positioning information to the at least one processor 250. The at least one processor 250 can generate corresponding movement information based on the positioning information of the terminal device 300 and the location of the device to be network-configured, thereby guiding the user to move the terminal device 300 according to the corresponding movement information.

Some embodiments of the present application also provide a server 400, including a communication module and a processing module. The communication module is configured to establish a communication connection with the terminal device 300, and the processing module is configured to: receive the device information of the device to be network-configured from the electronic device 200, where the terminal device 300 and the electronic device 200 are in the same network environment; send the device information to the terminal device 300; obtain the identification code information returned by the terminal device 300, where the identification code information is generated by the terminal device 300 scanning the pairing code corresponding to the device information; and send the identification code information to the electronic device 200, so that the electronic device 200 performs wireless communication scanning on network-configurable devices within the first preset range based on the identification code information, and when the electronic device 200 generates a first scanning result, the electronic device 200 establishes a second communication channel with the device to be network-configured and configures the network for the device to be network-configured via the second communication channel.

It is understood that the electronic device 200 can, via the aforementioned server 400, enable the terminal device 300 to perform the step of obtaining network-configurable device information from the device to be network-configured. In this embodiment, the terminal device 300 and the electronic device 200 may not establish a first communication channel with each other, and perform the interaction only through the server 400.

Some embodiments of the present application also provide a device network configuration method, including the following.

S100: In response to a network configuration command from the user, sending the device information of the device to be network-configured to the terminal device. Herein, the terminal device and the electronic device are in the same network environment.

S200: Obtaining identification code information via the first communication channel. Herein, the identification code information is generated by the terminal device scanning the pairing code corresponding to the device information.

S300: performing wireless communication scanning on network-configurable devices within a first preset range based on the identification code information.

S400: In response to generating a first scanning result, establishing a second communication channel with the device to be network-configured and configuring the network for the device to be network-configured via the second communication channel.

From the above technical solutions, the application provides an electronic device, a terminal device, and a device network configuration method. In response to a network configuration command from a user, the device information of the device to be network-configured is sent to the terminal device. Then, identification code information generated by the terminal device scanning the pairing code corresponding to the device information is obtained through a first communication channel. Based on the identification code information, the wireless communication scanning is performed on network-configurable devices within a first preset range. When a first scanning result is generated, a second communication channel is established with the device to be network-configured, thereby completing the network configuration for the device to be network-configured. In this application, the electronic device is connected to the terminal device, the terminal device scans a code on the device to be network-configured, and scanning is performed within the wireless communication range of the electronic device based on the identification code information of the device to be network-configured, facilitating the establishment of a connection between the electronic device and the device to be network-configured and improving the efficiency of network configuration between the electronic device and the device to be network-configured.

The embodiments of the present application provide a non-transitory computer-readable storage medium, storing computer programs. When executed by at least one processor, the computer programs implement each process executed by any of the methods provided in the above embodiments of the present application, and can achieve the same technical effect. To avoid repetition, details are not repeated here.

The non-transitory computer-readable storage medium may be a read-only memory (ROM), a random access memory (RAM), a magnetic disk, an optical disc, etc.

The present application provides a computer program product, containing computer programs. When run on a computer, the computer programs enable the computer to implement any method provided in the above embodiments of the present application.

For ease of explanation, the above description has been made in conjunction with specific embodiments. However, the above discussion in some embodiments is not intended to be exhaustive or to limit the embodiments to the specific forms disclosed above. Various modifications and deformations can be obtained in light of the above teachings. The above embodiments are chosen and described for the purpose of better explaining the principles and practical applications, enabling those skilled in the art to better use the embodiments and various different deformations of the embodiments suitable for specific use consideration.

What is claimed is:

1. An electronic device, comprising:
at least one processor configured to execute instructions to cause the electronic device to:
in response to receiving a device attestation certificate request from any one of mobile terminals of different brand manufacturers, send a device attestation certificate to the mobile terminal for the mobile terminal to perform security attestation based on the device attestation certificate;
in response to receiving a node operational certificate from the mobile terminal, install the node operational certificate and perform network configuration so that the electronic device and the mobile terminal both belong to one ecosystem; wherein, the electronic device is in different ecosystems to which the mobile terminals of different brand manufacturers belong, to be controlled by the mobile terminals in the different ecosystems;
receive operation information from the mobile terminal, determine a control command corresponding to the operation information based on the operation information and execute a corresponding operation according to the control command.

2. The electronic device according to claim 1, wherein the at least one processor is configured to execute the instructions to cause the electronic device to:
in response to receiving the node operational certificate from the mobile terminal, verify whether the node operational certificate is valid according to a root certificate, wherein the root certificate corresponds to the one ecosystem to which the mobile terminal belongs;
based on that the node operational certificate is valid, install the node operational certificate and perform the network configuration.

3. The electronic device according to claim 1, wherein the at least one processor is configured to execute the instructions to cause the electronic device to:
based on that the electronic device and the mobile terminal both belong to the one ecosystem, in response to the operation information received from the mobile terminal, determine whether the operation information is from the mobile terminal according to a root certificate, wherein the root certificate corresponds to the one ecosystem;
based on determining that the operation information is from the mobile terminal, determine the control command based on the operation information and execute the corresponding operation according to the control command; wherein the different ecosystems correspond to different control commands.

4. The electronic device according to claim 1, wherein the at least one processor is further configured to execute the instructions to cause the electronic device to:
obtain an access control list, wherein the access control list comprises information of an authorized terminal and authorized operation information corresponding to the authorized terminal;
wherein the at least one processor is further configured to execute the instructions to cause the electronic device to:
receive the operation information from the mobile terminal, wherein the operation information comprises information of the mobile terminal;
determine whether the mobile terminal is the authorized terminal based on the information of the mobile terminal and the information of the authorized terminal, and determine whether the operation information is the authorized operation information based on the operation information and the authorized operation information;
based on that the mobile terminal is the authorized terminal and the operation information is the authorized operation information, determine the control command based on the operation information and execute the corresponding operation according to the control command.

5. The electronic device according to claim 1, wherein the at least one processor is further configured to execute the instructions to cause the electronic device to:
control a communication device to broadcast so that the mobile terminal detects the electronic device;
in response to a feedback message from the mobile terminal, establish a wireless connection with the mobile terminal;
send a device parameter to the mobile terminal via the wireless connection for the mobile terminal to send the device attestation certificate request to the electronic device based on the device parameter.

6. The electronic device according to claim 1, wherein the at least one processor is further configured to execute the instructions to cause the electronic device to:
in response to receiving an attestation failure message from the mobile terminal, control a display to display prompt information, wherein the attestation failure message indicates that the electronic device has not passed the security attestation.

7. The electronic device according to claim 1, wherein the electronic device is a controlled device;
the at least one processor is configured to support a rich execution environment (REE) and a trusted execution environment (TEE); wherein the TEE stores a private key of the controlled device and does not provide the private key to an outside;
wherein the at least one processor is further configured to execute the instructions to cause the electronic device to:
in response to receiving an attestation request sent by a master device based on a Matter protocol stack in the REE, switch from the REE to the TEE, and sign attestation data with the private key in the TEE to obtain signed data;
switch from the TEE to the REE, and send the signed data to the master device based on the Matter protocol stack in the REE, so that the master device performs signature verification according to the signed data and configures a network for the controlled device.

8. The electronic device according to claim 7, wherein the at least one processor is further configured to execute the instructions to cause the electronic device to:
in the REE, call a TEE driver through a first interface to enter a monitor; wherein the monitor is configured to switch an execution environment of the controlled device between the REE and the TEE;
switch the REE to the TEE through the monitor.

9. The electronic device according to claim 7, wherein the at least one processor is further configured to execute the instructions to cause the electronic device to:
in the REE, call a second application through a first application; wherein the first application is an application running based on the REE, and the second application is a trusted application running based on the TEE;
in the TEE, obtain the private key through the second application;
use the private key to sign the attestation data to obtain the signed data through the second application.

10. A mobile terminal, comprising:
at least one processor configured to execute instructions to cause the mobile terminal to:
send a device attestation certificate request to an electronic device;
in response to receiving a device attestation certificate returned by the electronic device, send the device attestation certificate to a server for the server to perform security attestation;
in response to receiving an attestation success message returned by the server, send a node operational certificate to the electronic device so that the electronic device and the mobile terminal both belong to one ecosystem, wherein the attestation success message indicates that the electronic device passes the security attestation;
receive operation information from a user and send the operation information to the electronic device to control the electronic device based on the operation information.

11. A method for a mobile terminal to control an electronic device, comprising:
in response to receiving a device attestation certificate request from the mobile terminal, sending a device attestation certificate to the mobile terminal for the mobile terminal to perform security attestation based on the device attestation certificate; wherein the mobile terminal is any one of mobile terminals of different brand manufacturers;
in response to receiving a node operational certificate from the mobile terminal, installing the node operational certificate and performing network configuration so that the electronic device and the mobile terminal both belong to one ecosystem; wherein, the electronic device is in different ecosystems to which the mobile terminals of different brand manufacturers belong, to be controlled by the mobile terminals in the different ecosystems;
receiving operation information from the mobile terminal, determining a control command corresponding to the operation information based on the operation information and executing a corresponding operation according to the control command.

12. The method according to claim 11, further comprising:
in response to receiving the node operational certificate from the mobile terminal, verifying whether the node operational certificate is valid according to a root certificate, wherein the root certificate corresponds to the one ecosystem to which the mobile terminal belongs;
based on that the node operational certificate is valid, installing the node operational certificate and perform the network configuration.

13. The method according to claim 11, further comprising:
based on that the electronic device and the mobile terminal both belong to the one ecosystem, in response to the operation information received from the mobile terminal, determining whether the operation information is from the mobile terminal according to a root certificate, wherein the root certificate corresponds to the one ecosystem;
based on determining that the operation information is from the mobile terminal, determining the control command based on the operation information and executing the corresponding operation according to the control command; wherein the different ecosystems correspond to different control commands.

14. The method according to claim 11, further comprising:
obtaining an access control list, wherein the access control list comprises information of an authorized terminal and authorized operation information corresponding to the authorized terminal;
wherein the method further comprises:
receiving the operation information from the mobile terminal, wherein the operation information comprises information of the mobile terminal;
determining whether the mobile terminal is the authorized terminal based on the information of the mobile terminal and the information of the authorized terminal, and determining whether the operation information is the authorized operation information based on the operation information and the authorized operation information;
based on that the mobile terminal is the authorized terminal and the operation information is the authorized operation information, determining the control command based on the operation information and executing the corresponding operation according to the control command.

15. The method according to claim 11, further comprising:
controlling a communication device to broadcast so that the mobile terminal detects the electronic device;
in response to a feedback message from the mobile terminal, establishing a wireless connection with the mobile terminal;
sending a device parameter to the mobile terminal via the wireless connection for the mobile terminal to send the device attestation certificate request to the electronic device based on the device parameter.

16. The method according to claim 11, further comprising:
in response to receiving an attestation failure message from the mobile terminal, controlling a display to display prompt information, wherein the attestation failure message indicates that the electronic device has not passed the security attestation.

17. The method according to claim 1, wherein the electronic device is a controlled device; the electronic device is configured to support a rich execution environment (REE) and a trusted execution environment (TEE); wherein the TEE stores a private key of the controlled device and does not provide the private key to an outside;
wherein the method further comprises:
in response to receiving an attestation request sent by a master device based on a Matter protocol stack in the REE, switching from the REE to the TEE, and signing attestation data with the private key in the TEE to obtain signed data;
switching from the TEE to the REE, and sending the signed data to the master device based on the Matter protocol stack in the REE, so that the master device performs signature verification according to the signed data and configures a network for the controlled device.

18. The method according to claim 17, further comprising:
in the REE, calling a TEE driver through a first interface to enter a monitor; wherein the monitor is configured to switch an execution environment of the controlled device between the REE and the TEE;
switching the REE to the TEE through the monitor.

19. The method according to claim 17, further comprising:
in the REE, calling a second application through a first application; wherein the first application is an application running based on the REE, and the second application is a trusted application running based on the TEE;
in the TEE, obtaining the private key through the second application;
using the private key to sign the attestation data to obtain the signed data through the second application.

20. A non-transitory computer-readable storage medium, comprising: computer programs stored on the non-transitory computer-readable storage medium, wherein the computer programs, when executed by at least one processor, implement the method for the mobile terminal to control the electronic device according to claim 11.
